(19) United States
(12) Patent Application Publication
(10) Pub. No.: US 2010/0235756 A1
(43) Pub. Date: Sep. 16, 2010

(54) TRANSACTION SYSTEM, TRANSACTION PROCESSING DEVICE, SCREEN INFORMATION GENERATING METHOD, AND SCREEN INFORMATION GENERATION PROCESSING PROGRAM

(75) Inventor: Hiroyuki Yoshihama, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: Rakuten, Inc

(21) Appl. No.: 12/438,453

(22) PCT Filed: Aug. 2, 2007
(86) PCT No.: PCT/JP2007/065142

§ 371 Date: Feb. 23, 2009

(30) Foreign Application Priority Data
Aug. 22, 2006 (JP) 2006-224988

(51) Int. Cl. G06F 3/01; G06F 17/30

(52) U.S. Cl. 715/745; 707/803; 707/E17.044

(57) ABSTRACT

Provided are a transaction system, a transaction processing device, a screen information generating method and a screen information generation processing program capable of setting link information simply, giving a reward when an act relating to a transaction via the link information is committed, and also giving the reward without any work such as web site management, web page creation or the like.

The present invention provides a transaction processing device which provides a terminal device with screen information constituting a screen display of information relating to a transaction object via a network and registers in a database reward information showing a reward for an act performed relating to the transaction via link information embedded in the screen information.

The transaction processing device receives comment information on the transaction object input by a user from a comment input terminal device as the terminal device used by the user; recognizes user identification information for identifying the user who has input the comment information; generates the link information associated with a transaction of the transaction object commented by the received comment information and used for registering the reward information for the user identified by the recognized user identification information; generates the screen information constituting the screen display including the comment information in such a way that the generated link information is selectably embedded in association with the comment information; and sends the generated screen information to a read terminal device as the terminal device used by another user.

### TECHNICAL FIELD

The present invention relates to a technology of a transaction system, a transaction processing device, a screen information generating method and a screen information generation processing program for giving a reward for an act associated with a transaction committed, via link information embedded in screen information constituting a screen display of information about a transaction object.

### BACKGROUND ART

Conventionally, there is known a transaction system capable of using a terminal device such as a personal computer to connect to the network such as the Internet and accessing a web page or the like provided by a server or the like to conduct a transaction such as product purchase, service reservation and the like.

Besides, in relation to such a transaction system, there is known a so-called affiliate program (affiliate system) in which, when a user browsing an ad posted on a web site has purchased a product of the advertiser, made a service reservation or the like, the website operator of this web site is given a reward.

Here, description is given about an example of the affiliate program. First, an operator of a web site (affiliate site) applies for a membership of the affiliate program to be an affiliate member, logins to the web site of the affiliate program using a terminal device, and obtains a banner ad image and affiliate link. This affiliate link includes, for example, a URL (Uniform Resource Locator) of a purchase page of a product or the like as an ad target, an identifier for identifying the affiliate link and a member ID (Identification) for identifying an affiliate member, which are all set therein. Then, the affiliate member associates the obtained banner ad image with the affiliate link and posts it on the affiliate site web page.

Then, when a user browsing the web page selects the banner ad image, a request including the URL set in the affiliate link set in association with the banner ad image is sent from the terminal device to the advertiser web site (or affiliate program web site or the like). Then, a server device of the web site of the advertiser or the like recognizes the affiliate member from the member ID set in the affiliate link contained in this request and, when the user has conducted a product purchase or the like, the server device gives referral fee to the affiliate member identified by the member ID.

The patent document 1 discloses an invention of accumulating and managing, as client act information, acts such as product purchase done by a client accessing a commercial site of an advertiser in accordance with link information of an ad of an ad page of the affiliate site via a terminal and, when the same client accesses the affiliate site again, posting on the ad page an ad renewed based on the client act information.

### Patent Document 1: Japanese Patent Application Laid-Open No. 2001-283083

### DISCLOSURE OF THE INVENTION

### Problem to be Solved by the Invention

However, in the above-described conventional system, there is a need to set on the web page the user's affiliate link. This may be difficult for a person who is not familiar with the operation of a personal computer or the like or affiliate program. This prevents widespread use of the affiliate program.

On the other hand, in the invention disclosed in the patent document 1, there is no need to renew an ad to be posted once the link information is set on the ad page and the ad is posted. However, there still remains a problem that setting of the link information has to be done by the affiliate site operator.

Further, for a person who does not have any web site or web page, there is no object for setting the affiliate link, and it is difficult to start the affiliate program.

The present invention has been made in view of the foregoing and has an object to provide a transaction system, a transaction processing device, a screen information generating method and a screen information generation processing program capable of setting link information simply, giving a reward for an act committed in association with a transaction via the link information, and obtaining the reward without operating a web site or creating a web page.

### Means for Solving the Problem

In order to solve the above problem, the invention according to claim 1 relates to a transaction system comprising:

a terminal device connectable to a network; and

a transaction processing device providing screen information constituting a screen display of information concerning a transaction object to the terminal device via the network and registering in a database reward information showing a reward for an act concerning a transaction performed via link information embedded in the screen information,

the transaction processing device including:
comment information receiving means for receiving comment information on the transaction object input by a user from a comment input terminal device as the terminal device used by the user;
user identification information recognizing means for recognizing user identification information for identifying the user who has input the comment information;
link information generating means for generating the link information associated with the transaction object commented by the received comment information and used for registering the reward information for the user identified by the recognized user identification information;
screen information generating means for generating the screen information constituting the screen display including the comment information in such a way that the link information is selectably embedded in association with the comment information; and
screen information sending means for sending the generated screen information to a read terminal device as the terminal device used by another user,

the comment input terminal device including:
comment information sending means for sending the comment information input by the user to the transaction processing device, and

the read terminal device including:
screen information receiving means for receiving the screen information sent from the transaction processing device; and
display means for displaying the comment information on a screen based on the received screen information in such a way that the link information embedded is selectable.

According to this invention, the transaction processing device generates the link information for performing a transaction of the transaction object commented by the comment information input by the user and for registering the reward information for the user who has input the comment information when the act concerning the transaction of the commented transaction object is performed via the link information. Next, the transaction processing device selectably embeds the link information in the screen information in association with the comment information input by the user and sends this screen information to the read terminal device. Then, when another user has read the comment information displayed on the screen by the read terminal device based on the screen information and performed the act concerning the transaction by selecting the link information, the reward information is registered in the database in association with the user identification information of the user who has input the comment information.

Consequently, the screen information with the link information of the commented transaction object embedded therein is generated and provided to the terminal device only as a result of inputting the comment information. This allows the user to obtain the reward when another user has read the comment information and performed the act of the transaction, without conducting the web site management work, web page creation work or the like.

The invention according to claim 2 relates to a transaction system comprising:

a terminal device connectable to a network; and

a transaction processing device providing screen information constituting a screen display of information concerning a transaction object to the terminal device via the network and registering in a database reward information showing a reward for an act concerning a transaction performed via link information embedded in the screen information, including:
favorite designation information receiving means for receiving favorite designation information showing the transaction object designated as favorite by a user from a favorite designation terminal device as the terminal device used by the user;
user identification information recognizing means for recognizing user identification information for identifying the user who has performed the favorite designation;
link information generating means for generating the link information associated with the transaction object of the received favorite designation information and used for registering the reward information in association with the received user identification information in the database;
screen information generating means for generating the screen information constituting the screen display including favorite designation information showing that the transaction object designated is a favorite of the user in such a way that the generated link information is selectably embedded in association with the transaction object; and
screen information sending means for sending the generated screen information to a read terminal device as the terminal device used by another user,

the favorite designation terminal device including:
favorite designation information sending means for sending the favorite designation information showing the transaction object designated as favorite by the user to the transaction processing device, and

the read terminal device including:
screen information receiving means for receiving the screen information sent from the transaction processing device; and
display means for displaying the favorite designation information on a screen based on the received screen information in such a way that the link information embedded is selectable.

According to this invention, the transaction processing device generates the link information for performing a transaction of the transaction object designated as favorite by the user and for registering the reward information for the user who has performed the favorite designation when the act concerning the transaction of the favorite-designated transaction object is performed via the link information. Next, the transaction processing device selectably embeds the link information in the screen information in association with the transaction object designated by the user and sends this screen information to the read terminal device. Then, when another user has read the favorite information displayed on the screen by the read terminal device based on the screen information and performed the act concerning the transaction by selecting the link information associated with the transaction object, the reward information is registered in the database in association with the user identification information of the user who has performed the favorite designation.

Consequently, the screen information with the link information of the favorite transaction object embedded therein is generated and provided to the terminal device only as a result of designating the favorite transaction object. This allows the user to obtain the reward when another user has read the favorite information and performed the act of the transaction, without conducting the web site management work, web page creation work or the like.

The invention according to claim 3 relates to a transaction processing device providing screen information constituting a screen display of information concerning a transaction object to a terminal device via a network and registering in a database reward information showing a reward for an act concerning a transaction performed via link information embedded in the screen information,

the transaction processing device comprising:

comment information receiving means for receiving comment information on the transaction object input by a user from a comment input terminal device as the terminal device used by the user;

user identification information recognizing means for recognizing user identification information for identifying the user who has input the comment information;

link information generating means for generating the link information associated with a transaction of the transaction object commented by the received comment information and used for registering the reward information for the user identified by the recognized user identification information;

screen information generating means for generating the screen information constituting the screen display including the comment information in such a way that the generated link information is selectably embedded in association with the comment information; and

screen information sending means for sending the generated screen information to a read terminal device as the terminal device used by another user.

According to this invention, the transaction processing device generates the link information for performing a transaction of the transaction object commented by the comment information input by the user and for registering the reward information for the user who has input the comment information when the act concerning the transaction of the commented transaction object is performed via the link information. Next, the transaction processing device selectably embeds the link information in the screen information in association with the comment information input by the user and sends this screen information to the read terminal device. Then, when another user has read the comment information displayed on the screen by the read terminal device based on the screen information and performed the act concerning the transaction by selecting the link information, the reward information is registered in the database in association with the user identification information of the user who has input the comment information.

Consequently, the screen information with the link information associated with the commented transaction object embedded therein is generated and provided to the terminal device only as a result of inputting the comment information. This allows the user to obtain the reward when another user has read the comment information and performed the act of the transaction, without conducting the web site management work, web page creation work or the like.

The invention according to claim 4 relates to the transaction processing device according to claim 3,

wherein in the database, transaction information of the transaction object previously transacted by the user is registered in association with the user identification information of the user, and

the link information generating means generates the link information in association with the comment information commenting on the transaction object shown by the transaction information associated with the recognized user identification information.

According to this invention, the screen information with the link information embedded therein is generated when the user has input the comment information on the transaction object previously transacted by the user. This makes it possible for another user to conduct a transaction after reading the proper comment information on the transaction object.

The invention according to claim 5 relates to the transaction processing device according to claim 3 or 4, further comprising:

comment information registering means for registering the received comment information in the database in association with the recognized user identification information and registering transaction object identification information of the transaction object commented by the comment information in the database in association with the comment information,

wherein the link information generating means generates the link information associated with the transaction of the transaction object identified by the transaction object identification information associated with the registered comment information in such a manner as to allow the user identification information associated with the comment information to be specified, and

the screen information generating means generating the screen information of the registered comment information.

According to this invention, the comment information is registered in the database and this registered comment information and the like are used to generate the screen information. This makes it possible to provide the terminal device with the screen information in accordance with a status after registration or the like.

The invention according to claim 6 relates to a transaction processing device providing screen information constituting a screen display of information concerning a transaction object to a terminal device via a network and registering in a database reward information showing a reward for an act concerning a transaction performed via link information embedded in the screen information, the transaction processing device comprising:

favorite designation information receiving means for receiving favorite designation information showing the transaction object designated as favorite by a user from a favorite designation terminal device as the terminal device used by the user;

user identification information recognizing means for recognizing user identification information for identifying the user who has performed the favorite designation;

link information generating means for generating the link information associated with a transaction of the transaction object shown by the received favorite designation information and used for registering the reward information in association with the recognized user identification information in the database;

screen information generating means for generating the screen information constituting the screen display including favorite information showing that the transaction object designated is a favorite of the user in such a way that the generated link information is selectably embedded in association with the transaction object; and

screen information sending means for sending the generated screen information to a read terminal device as the terminal device used by another user.

According to this invention, the transaction processing device generates the link information for performing a transaction of the transaction object designated as favorite by the user and for registering the reward information for the user who has performed the favorite designation when the act concerning the transaction of the favorite-designated transaction object is performed via the link information. Next, the transaction processing device selectably embeds the link information in the screen information in association with the transaction object designated by the user and sends this screen information to the read terminal device. Then, when another user has read the favorite information displayed on the screen by the read terminal device based on the screen information and performed the act concerning the transaction by selecting the link information associated with the transaction object, the reward information is registered in the database in association with the user identification information of the user who has performed the favorite designation.

Consequently, the screen information with the link information associated with the favorite transaction object embedded therein is generated and provided to the terminal device only as a result of designating the favorite transaction object. This allows the user to obtain the reward when another user has read the favorite information and performed the act of the transaction, without conducting the web site management work, web page creation work or the like.

The invention according to claim 7 relates to the transaction processing device according to claim 6,

wherein in the database, transaction information of the transaction object previously transacted by the user is registered in association with the user identification information of the user, and

the link information generating means generates the link information in association with favorite designation by the user of the transaction object shown by the transaction information associated with the recognized user identification information.

According to this invention, the screen information with the link information embedded therein is generated when the user has designated as favorite transaction the transaction object previously transacted by the user. This makes it possible for another user to conduct a transaction after reading the proper favorite information on the transaction object.

The invention according to claim 8 relates to the transaction processing device according to claim 6 or 7,

wherein in the database, favorite management information for managing the favorite information is registered in association with the user identification information,

the transaction processing device further comprises favorite information registering means for registering transaction object identification information for identifying the transaction object shown by the received favorite designation information in the favorite management information associated with the recognized user identification information,

the link information generating means generates the link information associated with the transaction of the transaction object identified by the registered transaction object identification information in such a manner as to allow the user identification information associated with the favorite management information to be specified, and

the screen information generating means generates the screen information of the favorite information of the transaction object identified by the registered transaction object identification information.

According to this invention, the transaction object identification information of the favorite-designated transaction object is registered in the database and this registered transaction object identification information and the like are used to generate the screen information. This makes it possible to provide the terminal device with the screen information in accordance with a status after registration or the like.

The invention according to claim 9 relates to the transaction processing device according to any one of claims 3 to 8,

wherein the link information generating means generates the link information in such a manner as to allow the recognized user identification information to be specified, and

the transaction processing device further comprises:
access request information receiving means for receiving access request information containing the link information and sent from the read terminal device based on selection of the link information by the other user via the sent screen information;
transaction object screen information sending means for sending the read terminal device, transaction object screen information constituting a screen display required for performing a transaction of the transaction object associated with the link information contained in the received access request information;
transaction request receiving means for receiving transaction request information showing a transaction request sent based on a direction of the other user from the read terminal device which has received the sent transaction object screen information;
transaction registering means for registering in the database transaction registration information showing registration of the transaction based on the received transaction registration information;
transaction fixing recognizing means for recognizing fixing of the transaction shown by the registered transaction registration information; and
reward information registering means for registering the reward information in association with the user identification information specified by the link information contained in the access request information in at least one case of a case where the access request information is received, a case where the transaction registration information is registered and a case where fixing of the transaction is recognized.

According to this invention, another user can conduct a transaction with use of the read terminal device and the reward information can be registered in at least one of the case where the link information is selected by another user, the case where the transaction registration is performed and the case where the transaction is fixed.

The invention according to claim 10 relates to a screen information generating method for a transaction processing device providing screen information constituting a screen display of information concerning a transaction object to a terminal device via a network and registering in a database reward information showing a reward for an act concerning a transaction performed via link information embedded in the screen information, the screen information generating method comprising:

a comment information receiving process of receiving comment information on the transaction object input by a user from a comment input terminal device as the terminal device used by the user;

a user identification information recognizing process of recognizing user identification information for identifying the user who has input the comment information;

a link information generating process of generating the link information associated with the transaction object commented by the received comment information and used for registering the reward information for the user identified by the recognized user identification information;

a screen information generating process of generating the screen information constituting the screen display including the comment information in such a way that the generated link information is selectably embedded in association with the comment information; and

a screen information sending process of sending the generated screen information to a read terminal device as the terminal device used by another user.

The invention according to claim 11 relates to a screen information generating method for a transaction processing device providing screen information constituting a screen display of information concerning a transaction object to a terminal device via a network and registering in a database reward information showing a reward for an act concerning a transaction performed via link information embedded in the screen information,

the screen information generating method comprising:

a favorite designation information receiving process of receiving favorite designation information showing the transaction object designated as favorite by a user from a favorite designation terminal device as the terminal device used by the user;

a user identification information recognizing process of recognizing user identification information for identifying the user who has performed the favorite designation;

a link information generating process of generating the link information associated with a transaction of the transaction object shown by the received favorite designation information and used for registering the reward information in association with the recognized user identification information in the database;

a screen information generating process of generating the screen information constituting the screen display including favorite information showing that the transaction object designated is a favorite of the user in such a way that the link information is selectably embedded in association with the transaction object; and

a screen information sending process of sending the generated screen information to a read terminal device as the terminal device used by another user.

The invention according to claim 12 relates to a screen information generation processing program for a computer included in a transaction processing device providing screen information constituting a screen display of information concerning a transaction object to a terminal device via a network and registering in a database reward information showing a reward for an act concerning a transaction performed via link information embedded in the screen information, the screen information generation processing program making the computer function as:

comment information receiving means for receiving comment information on the transaction object input by a user from a comment input terminal device as the terminal device used by the user;

user identification information recognizing means for recognizing user identification information for identifying the user who has input the comment information;

link information generating means for generating the link information associated with a transaction of the transaction object commented by the received comment information and used for registering the reward information for the user identified by the recognized user identification information;

screen information generating means for generating the screen information constituting the screen display including the comment information in such a way that the link information is selectably embedded in association with the comment information; and

screen information sending means for sending the generated screen information to a read terminal device as the terminal device used by another user.

The invention according to claim 13 relates to a screen information generation processing program for a computer included in a transaction processing device providing screen information constituting a screen display of information concerning a transaction object to a terminal device via a network and registering in a database reward information showing a reward for an act concerning a transaction performed via link information embedded in the screen information,

the screen information generation processing program making the computer function as:

favorite designation information receiving means for receiving favorite designation information showing the transaction object designated as favorite by a user from a favorite designation terminal device as the terminal device used by the user;

user identification information recognizing means for recognizing user identification information for identifying the user who has performed the favorite designation;

link information generating means for generating the link information associated with a transaction of the transaction object shown by the received favorite designation information and used for registering the reward information in association with the recognized user identification information in the database;

screen information generating means for generating the screen information constituting the screen display including favorite information showing that the transaction object designated is a favorite of the user in such a way that the link information is selectably embedded in association with the transaction object; and

screen information sending means for sending the generated screen information to a read terminal device as the terminal device used by another user.

The invention according to claim 14 relates to a transaction processing device for providing information concerning a transaction object to a terminal device via a network, comprising:

comment information receiving means for receiving comment information on the transaction object sent from the terminal device based on inputting of a comment by a user;

link generating means for generating an affiliate link containing user identification information for identifying the user who has input the comment;

screen information generating means for generating screen information containing the link and the comment information; and

screen information sending means for sending the generated screen information to another terminal device.

According to this invention, the transaction processing device receives the comment information sent from the terminal device based on the comment input by the user, and generates the affiliate link containing the user identification information of the user who has input the comment. Next, the transaction processing device generates the screen information containing the generated affiliate link and the comment information and sends this screen information to another terminal device. Then, when another user has read the comment information displayed on the screen by another terminal device based on the screen information and performed the act concerning the transaction by selecting the affiliate link, the reward is given to the user identified by the user identification information contained in the affiliate link, that is, the user who has input the comment.

Consequently, the screen information with the affiliate link is generated and provided to the terminal device only as a result of inputting the comment information. This allows the user to obtain the affiliate reward when another user has read the comment and performed the act of the transaction, without conducting the web site management work, web page creation work or the like.

The invention according to claim 15 relates to a transaction processing device for providing information concerning a transaction object to a terminal device via a network, comprising:

favorite designation information receiving means for receiving favorite designation information on the transaction object designated as favorite sent from the terminal device based on input by a user;

link generating means for generating an affiliate link containing user identification information for identifying the user;

screen information generating means for generating screen information containing the link and information of the transaction object designated as favorite; and

screen information sending means for sending the generated screen information to another terminal device.

According to this invention, the transaction processing device receives the favorite designation information showing the transaction object designated as favorite by the user, and generates the affiliate link containing the user identification information of the user who has performed the favorite designation. Next, the transaction processing device generates the screen information containing the generated affiliate link and information showing the favorite-designated transaction object and sends this screen information to another terminal device. Then, when another user has read the information displayed as user's favorite on the screen of another terminal device based on the screen information and performed the act concerning the transaction by selecting the affiliate link, the reward is given to the user identified by the user identification information contained in the affiliate link, that is, the user who has performed the favorite designation.

Consequently, the screen information with the affiliate link is generated and provided to the terminal device only as a result of designating the favorite transaction object. This allows the user to obtain the affiliate reward when another user has read the comment and performed the act of the transaction, without conducting the web site management work, web page creation work or the like.

### EFFECT OF THE INVENTION

According to the present invention, the screen information having embedded therein link information associated with a commented transaction object is generated simply by inputting comment information, or the screen information having embedded therein link information associated with a favorite transaction object is generated simply by designating the favorite transaction object, and then, the generated screen information is provided to the terminal device. With this structure, the user can be given a reward when another user reading the comment information commits an act concerning the transaction without performing any operations such as web site operation, web page creation and the like.

### BRIEF DESCRIPTION OF THE DRAWINGS

FIG. 1 is a view illustrating an example of the outline structure of a golf course reservation system S according to the present embodiment;

FIG. 2 is a block diagram showing an example of the outline structure of a golf course reservation server 1 according to the present embodiment;

FIG. 3 is a view showing an example of information contents registered in a member information database 101;

FIG. 4 is a view showing an example of information contents registered in a member use information database 102;

FIG. 5A is a view showing a structural example of favorite golf course information and FIG. 5B is a view showing a structural example of comment management information;

FIG. 6 is a view showing an example of information contents registered in a ranking information database 103;

FIG. 7 is a view showing an example of information contents registered in a golf course database 104;

FIG. 8 is a view showing a display example of a “my page” 300;

FIG. 9 is a view showing a display example of a voice center top page 400;

FIG. 10 is a view showing a display example of a golf course voice center page 500;

FIG. 11 is a view showing a display example of a personal voice center top page 600;

FIG. 12 is a view showing a display example of a personal voice center golf course page 700;

FIG. 13 is a view showing a display example of a comment detail page 800;

FIG. 14A is a view showing a display example of a comment writing number ranking page 900 and FIG. 14B is a view showing a display example of a favorite poster ranking page 950;

FIG. 15 is a view showing a display example of a favorite poster management page 1000;

FIG. 16 is a view showing a display example of a comment posting page 1100;

FIG. 17 is a sequence diagram showing an example of a processing flow in the golf course reservation systems according to the present embodiment;

FIG. 18 is a flow chart showing an example of a processing flow in comment registration processing of a system controller 20 of the golf course reservation server 1 according to the present embodiment;

FIG. 19 is a flow chart showing an example of a processing flow in favorite golf course registration processing of the system controller 20 of the golf course reservation server 1 according to the present embodiment;

FIG. 20 is a flow chart showing an example of a processing flow in affiliate control processing of the system controller 20 of the golf course reservation server 1 according to the present embodiment;

FIG. 21 is a flow chart showing an example of a processing flow in reservation processing of the system controller 20 of the golf course reservation server 1 according to the present embodiment;

FIG. 22 is a flow chart showing an example of a processing flow in reservation canceling processing of the system controller 20 of the golf course reservation server 1 according to the present embodiment;

FIG. 23 is a flow chart showing an example of a processing flow in golf play fixing processing of the system controller 20 of the golf course reservation server 1 according to the present embodiment; and

FIG. 24 is a flowchart showing an example of a processing flow in reservation processing of the system controller 20 of the golf course reservation service 1 according to a modification of the present embodiment.

### DESCRIPTION OF REFERENCE NUMERALS

1 golf course reservation server
3-j golf course terminal
4-k user terminal
11 operating part
12 display part
13 communication part
14 drive part
15 storage part
16 input/output interface
17 CPU
18 ROM
19 RAM
20 system controller
21 system bus
101 member information database
102 member use information database
103 ranking information database
104 golf course information database
NW network
S golf course reservation system

### PREFERRED EMBODIMENT FOR CARRYING OUT THE INVENTION

With reference to the drawings, a preferred embodiment of the present invention will be described in detail below. Here, in the following embodiment, the present invention is applied to a golf course reservation system.

### [1. Structure and Functional Overview of Golf Course Reservation System]

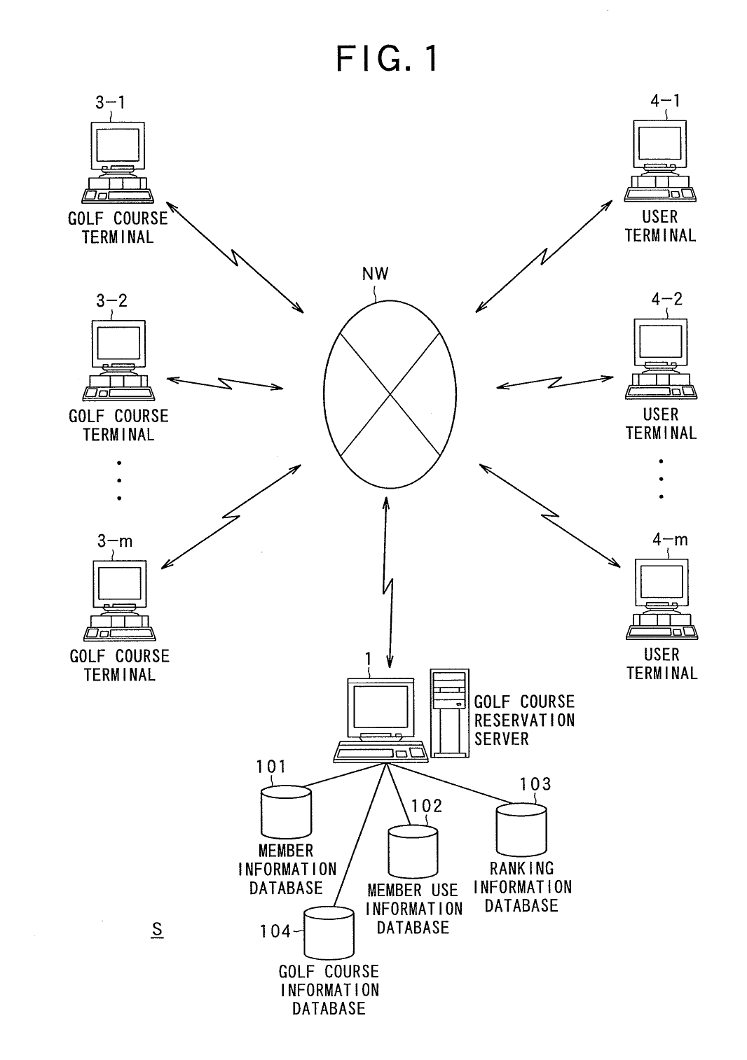

First, the structural and functional overview of the golf course reservation system S according to this embodiment is described with reference to FIG. 1.

FIG. 1 is a view illustrating an example of the outline structure of the golf course reservation system S according to the present embodiment.

As illustrated in FIG. 1, the golf course reservation system S includes a golf course reservation server 1 as an example of the transaction processing device including, as examples of the database, a member information database 101, a member use information database 102, a ranking information database 103 and a golf course information database 104; golf course terminals 3-j (j=1, 2, . . . , m); and user terminals 4-k (k=1, 2, . . . , m) as an example of the terminal device.

The golf course reservation server 1, the golf course terminals 3-j and the user terminals 4-k are capable of sending and receiving data with one another via the network NW using, for example, a communication protocol of TCP/IP (Transmission Control Protocol/Internet Protocol) or the like. Here, the network NW is constructed of, for example, the Internet, dedicated communication lines (such as CATV (Community Antenna Television) line), a mobile communication network (including base stations), a gateway and the like.

In the thus-constructed golf course reservation system S, the golf course reservation server 1 is a server device installed for establishing a golf course reservation site by a service provider who provides various services via the network NW.

This service provider receives reservations under a commission from a provider of golf course services (an example of transaction object), and golf course information about this golf course, the limit number of available reservations under the commission, reservation status and the like are registered in the golf course database 104. Then, the golf course reservation system S provides a golf course reservation service to a user utilizing a user terminal 4-k by the golf course reservation server 1 processing golf course reservation registration in response to a request from the user terminal 4-k via the network NW.

In order to use this golf course reservation service, the user conducts member registration in the golf course reservation system S to be allowed to use the golf course reservation service provided by the system (hereinafter, the user who can use the golf course reservation service is referred to as a “member”). Member information and the like relating to the registered members is stored in the member information database 101.

When the member has utilized the golf course reservation system S to make a reservation of the golf course and actually used the reserved golf course, he is given points corresponding to the fee the member paid for use of the golf course or the like. Then, the member can use the given points to cover a part or all of the fee for making a reservation of the golf course using the golf course reservation system S or to apply for drawing (lottery, etc.) which presents a prize or the like when he wins. The information about these points is also registered in the member information database 101.

The contents (services) provided by the golf course reservation system S to the member is not only golf course reservation. The golf course reservation system S also provides a content of voice center for posting a comment on the golf course, registering his chosen golf course or favorite golf course as his own favorite and allowing other members to read this information.

In order to allow the members to read such comment (an example of comment information) or favorite golf courses (an example of favorite information), the golf course reservation server 1 generates a voice center page (an example of screen information) which is a web page displaying the comment and the registered favorite golf courses (specifically, generates the HTML (Hyper Text Markup Language) data thereof), and sends this voice center page to a user terminal 4-k in response to a request from the user terminal 4-k. When generating this voice center page, the golf course reservation server 1 sets on the page an affiliate link associated with the comment and favorite golf courses to be displayed.

When the voice center page is displayed on the screen by the user terminal 4-k and the member reads the comment and a list of golf courses shown as favorite and selects an affiliate link associated with this information, the display on the screen moves to a reservation page of a golf course associated with this affiliate link (in the case of the comment, the commented golf course). Then, when this reservation page is used to make a reservation of the golf course, a member associated with this selected affiliate link, or a member who has posted the comment or registered the favorite golf course, is given the above-mentioned points.

In this way, once the member of the golf course reservation system S simply posts a comment or registers his favorite golf course, he can get the affiliate reward as points when the affiliate link is used to make a golf course reservation.

The above-mentioned comment and favorite information or the like is registered in the member use information database 102. Herein, a member who has posted a comment is also referred to as “comment poster” and a member who has registered (designated) his favorite golf course is also referred to as “favorite registrant”.

The golf course terminal 3-j is a terminal device used by a golf course worker or the like, and, for example, a personal computer or the like can be applied thereto. The golf course terminal 3-j accesses the golf course reservation server 1 to obtain reservation status or the like registered in the golf course information data base 104, for display on the screen. Thus, the golf course worker or the like can manage the golf course reservations (for example, referring to the reservation details, canceling a reservation or the like).

The user terminal 4-k is a terminal device which accesses the golf course reservation server 1 to obtain a web page for display on the screen so that a user can use this web page to make a golf course reservation, register scores, post comments, register favorite golf courses, view or read such information and the like. For example, a personal computer, a PDA (Personal Digital Assistant), an STB (Set Top Box), a portable phone or the like in which a web browser application, electronic mail application and the like are installed may be applied to the user terminal 4-k.

### [2. Structure and Functions of the Golf Course Reservation Server]

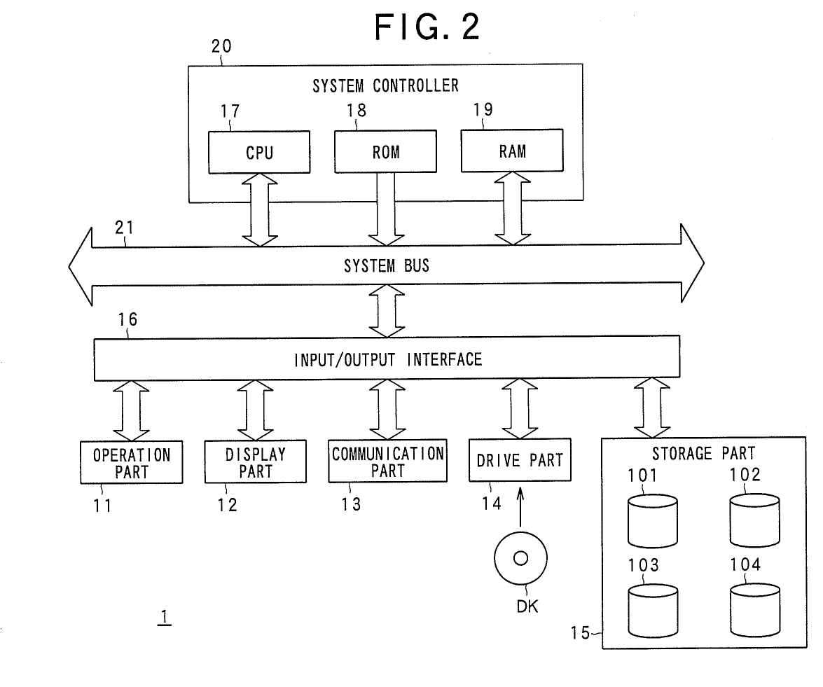

Next description is made about the structure and functions of the golf course reservation server 1 with reference to FIGS. 2 to 7.

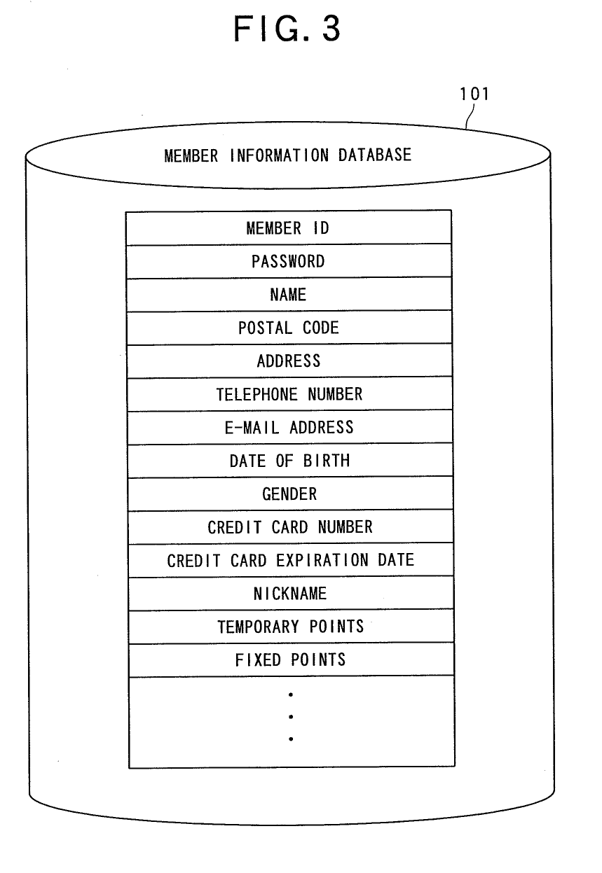

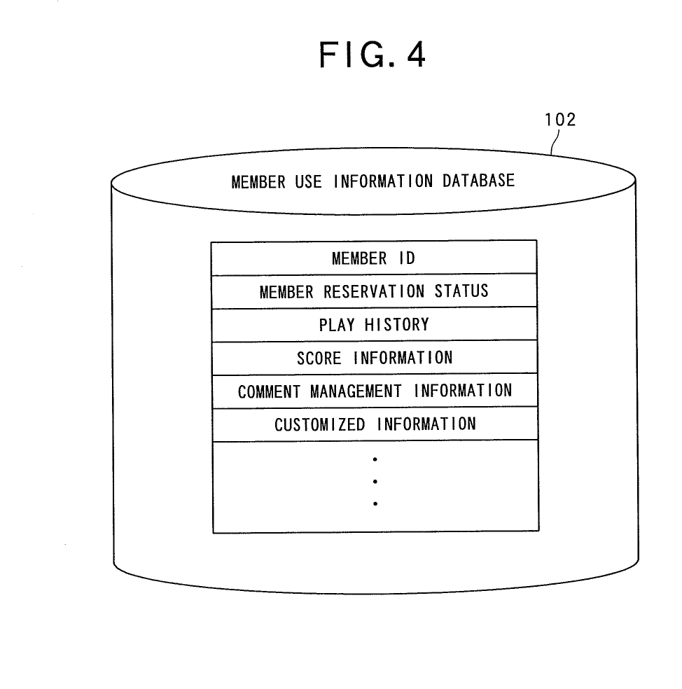

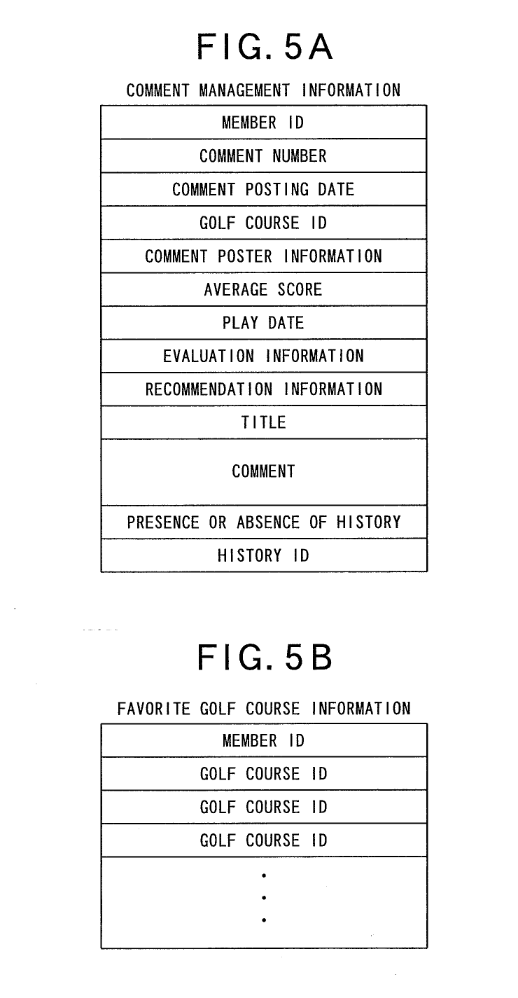

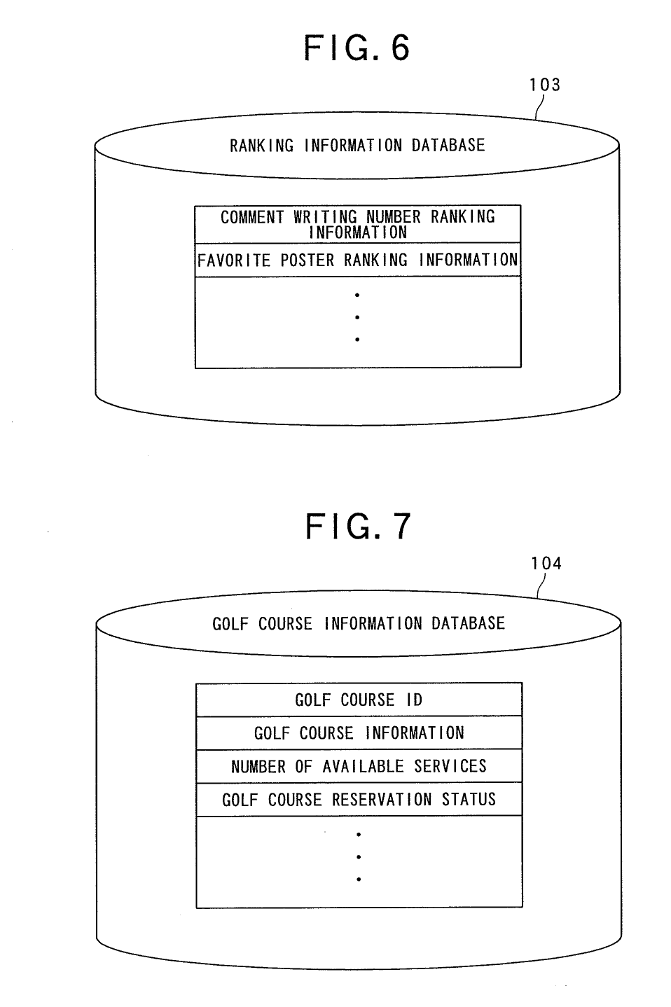

FIG. 2 is a block diagram showing an example of the outline structure of the golf course reservation server 1 according to the present embodiment. FIG. 3 is a view showing an example of information contents registered in the member information database 101. FIG. 4 is a view showing an example of information contents registered in the member use information database 102. FIG. 5A is a view showing a structural example of comment management information, and FIG. 5B is a view showing a structural example of the favorite golf course information. FIG. 6 is a view showing an example of information contents registered in the ranking information database 103. FIG. 7 is a view showing an example of information contents registered in the golf course database 104.

As shown in FIG. 2, the golf course reservation server 1 includes an operating part 11 (for example, a keyboard, a mouse and the like) for receiving an operation direction from an operator or the like and outputting the operation direction as a direction signal to a system controller 20, a display part 12 (for example, CRT (Cathode Ray Tube) display, liquid crystal display and the like) for displaying information of texts, images and the like, a communication part 13 for connecting to the network NW to control communication status among the golf course terminals 3-j, user terminals 4-k and the like, a drive part 14 for reading data or the like from a disk DK such as a flexible disk, a CD (Compact Disc) or a DVD (Digital Versatile Disc) and recording the data or the like in the disk DK, a storage part 15 (for example, a hard disk drive or the like) for storing various programs and data, an input/output interface part 16 for performing interface processing between the operating part 11 to the storage part 15 and the system controller 20, and the system controller 20 including a CPU (Central Processing Unit) 17, a ROM (Read Only Memory) 18, a RAM (Random Access Memory) 19 and the like. The system controller 20 and the input/output interface 16 are connected to each other via a system bus 21.

The storage part 15 has the member information database 101, the member use information database 102, the ranking information database 103 and the golf course database 104 built therein.

First, as shown in FIG. 3, the member information database 101 has member information relating to members of the golf course reservation system S registered in association with member IDs for identifying the members (an example of user identification information). Specifically, the member information includes, as shown in FIG. 3, for example, member ID, login password, member name, postal code, address, telephone number, electronic mail address, date of birth, gender, credit card number and the expiration date thereof, nickname, fixed points, temporary points and the like.

Here, the fixed points and temporary points are information showing the above-described points, which are given when a member makes a golf course reservation utilizing the golf course reservation system S and also given as an affiliate reward. When the member make a golf course reservation, temporary points corresponding to the fee or the like is given to the member, and if a reservation is made via the affiliate link, temporary points are also given as the affiliate reward to the comment poster and the favorite registrant associated with the affiliate link. Then, when payment of the fee is completed (the golf course reservation server 1 recognizes clearance of the payment when a golf playing day has come without canceling the reservation) and use of the golf course is fixed, the temporary points given to each member are changed into fixed points. Then, the member becomes able to use these fixed points for golf course reservation or the like.

As shown in FIG. 4, the member use information database 102 includes member reservation status, play history, score information, comment management information, customized information and the like, which are registered in association with the member ID.

The member reservation status is information showing details, status and the like of golf course reservation for each member.

In addition, this member reservation status registers member reservation information (reservation registered information) showing reservation details of each reservation in association with a reservation number assigned to this reservation. The member reservation information includes, for example, reservation number, golf course ID of a reserved golf course (information for identifying the golf course), course, play date, play start time, number of reserved groups and players, fee, reservation points, affiliate information and the like.

Here, the reservation points are points given to a member who has made a reservation.

The affiliate information is information set when a reservation is made via the affiliate link, the information including member ID of a comment poster or favorite registrant associated with the affiliate link (which member ID is of a comment poster who has posted a comment when the affiliate link is embedded in the voice center page in association with the comment or of a favorite registrant who has registered a favorite golf course when the affiliate link is embedded in the voice center page in association with the favorite golf course) and reward points given as a reward to the comment poster or the favorite registrant.

The play history (an example of transaction information) is information showing a history of playing golf in the reserved golf course. In this play history, for example, play date, golf course ID of the golf course where he played, course, number of playing groups, number of players, names of accompanying players, weather, score ID for identifying score information of a play result, comment number given to comment management information (described later, see FIG. 5(a)) and the like are set per play (one reservation) in association with a history ID.

The score information is information showing a golf score and the like of a member, including, for example, per one play, number of putts, number of OBs, presence or absence of fairway keep, comment, play date, golf course ID of the golf course where he played, course, green type, used tee, weather, wind strength, round memo, accompanying golf player ID, score (number of shots) for each hole, which are all set in association with the score ID.

The comment management information is information for managing comments, evaluations and the like on golf courses posted by the members, and includes, as shown in FIG. 5A, comment number uniquely assigned to each comment, comment posting date, golf course ID of the golf course on which the comment is posted, comment poster information, average score, play date, evaluation information, recommendation information, comment title, comment, presence or absence of play history and history ID.

Here, the comment poster information is information showing whether or not to display information on the comment poster (nickname, location, age, gender and number of uses of the system) in posting the comment on the voice center page.

The evaluation information is information for showing an evaluation of each item (overall, staff service, meal, course, cost performance, clubhouse) of the golf course on a five-point scale by the comment poster.

The recommendation information is information showing a recommended purpose of use of the golf course (competition, golf play with friends, business entertainment, golf play in a couple, single play) or player type (long hitter, beginner, advanced player, athlete, female).

The comment is information input by a user, basically including the user's feedbacks on playing at the golf course and opinions on the golf course. Any comment can be posted, which may be, for example, explanation, commentary, review, ads on the golf course, and the like.

The presence or absence of play history is information showing whether the comment is posted in association with the play history or not. In other words, the presence or absence of play history is information showing whether or not the comment is posted by a member who has used the golf course reservation system S to make a reservation of the golf course and actually played golf at the golf course. When this presence or absence of play history is set to “yes” (presence), the associated play history ID is added.

In this system, it is possible to post a comment not only on a golf course of which a reservation is made, but also on a golf course of which no reservation is made. However, in posting a comment on the voice center page, only the former comment is given an affiliate link, while the latter comment is not given an affiliate link and a normal link to move to a reservation page is set therefor. The presence or absence of play history is information for identifying whether the posted comment is the former comment or the latter comment.

The reason for such configuration is as follows: In the former case, the golf course is actually used and a proper comment thereon is expected. Accordingly, it is reasonable that a member who has posted such a proper comment is to be given an affiliate reward. However, the above-described configuration is not absolutely essential. For example, an affiliate link may also be set in the latter case, or comment posting may be allowed only on a golf course for which a reservation is made.

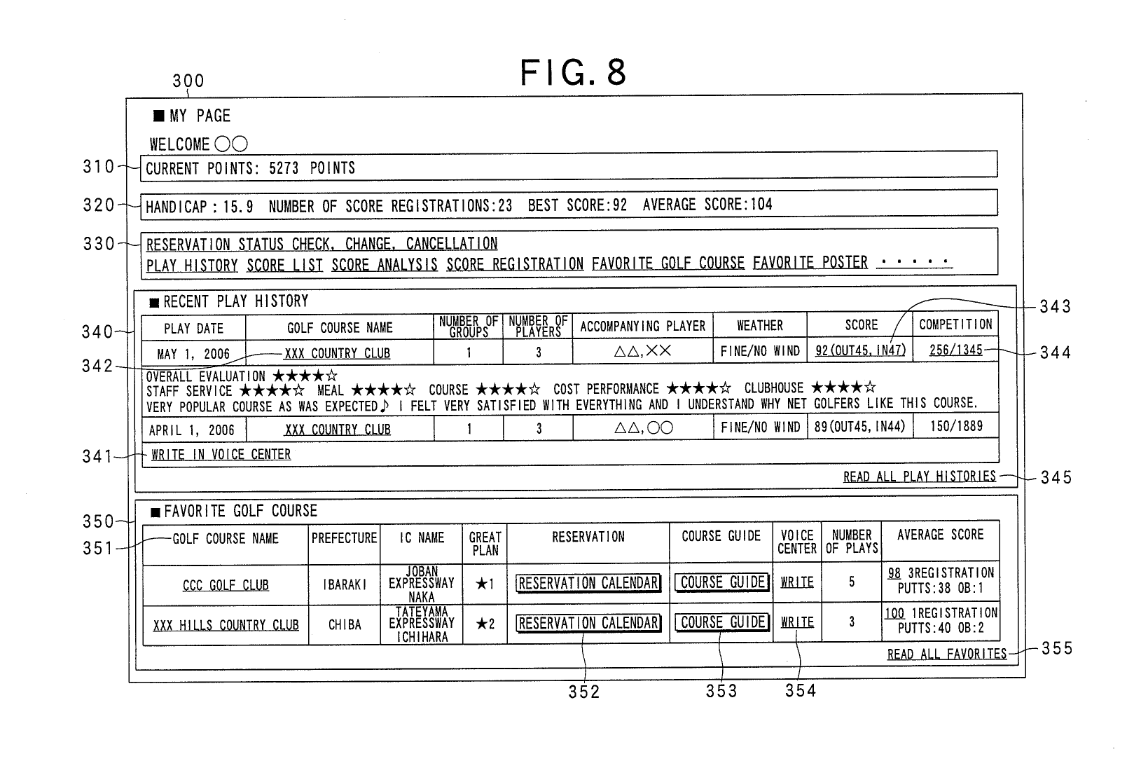

The customized information includes, for example, display setting of a later-described member's my page 300 (see FIG. 8), favorite golf course information, favorite poster information and the like.

In the favorite golf course information, as shown in FIG. 5B, a golf course ID of a golf course registered (designated) as favorite (favorite golf course) by a member is set in association with a member ID.

In this system, favorite registration of a golf course is allowed for not only a golf course for which a reservation is made but also a golf course for which a reservation is not made. And, unlike the above-mentioned case for the comment, when a favorite golf course is posted on the voice center page, an affiliate link is set whether the favorite registration is made for the former or the latter.

Needless to say, the above-mentioned configuration is not absolutely essential. For example, the affiliate link may not be set for the golf course registered as favorite in the latter case, or only a golf course of which a reservation is made may be made registrable as favorite.

In the favorite poster information, a member ID of a comment poster whom a member has registered (designated) as favorite is set in association with a member ID of the user.

Here, information registered in the member information database 101 and information registered in the member use information database 102 are both associated with a member ID. Therefore, these databases may be integrated into one database.

Next, as shown in FIG. 6, in the ranking information database 103, comment writing number ranking information, favorite poster ranking information and the like are registered.

The comment writing number ranking information is information on comment posters ranked based on the number of comments on golf courses. For example, member ID, number of comments, and number of uses of the golf course reservation system S of a comment poster are set in association with the rank.

The favorite poster ranking information is information on comment posters ranked based on the number of registrations as favorite poster. For example, member ID, number of favorite registrations, and number of uses of the golf course reservation system S of a comment poster are set in association with the rank.

Next, as shown in FIG. 7, in the golf course information database 104, information about each golf course including golf course information, number of available services, golf course reservation status and the like is registered in association with the golf course ID.

The golf course information includes, for example, basic information of a golf course (e.g., name, address, postal code, telephone number, facsimile number, electronic mail address), course information (e.g., course description, course rate, yardage and number of putts for each hole), guide information, fee, evaluations on the golf course and the like.

The number of available services is, for example, the number of reservations that can be fixed in one day by a service provider under a commission from the golf course owner.

The golf course reservation status is information showing details, status and the like of golf course reservation per golf course. In this golf course reservation status, for example, golf course reservation information showing details of each reservation is registered in association with a reservation number assigned to the reservation. The golf course reservation information includes, for example, reservation number, member ID of a member who has made the reservation, course, play date, play start time, reserved number of players, fee and the like.

For example, the golf course reservation status and the member reservation status may be unified to be registered in the golf course information database 104 as a reservation status, and only the reservation number may be registered in the member use information database 102, and the reservation number being associated with the reservation information registered in the golf course information database 104.

In addition, in the storage part 15, HTML data, image data, speech data, text data and the like constituting a web page of the golf course reservation site are stored.

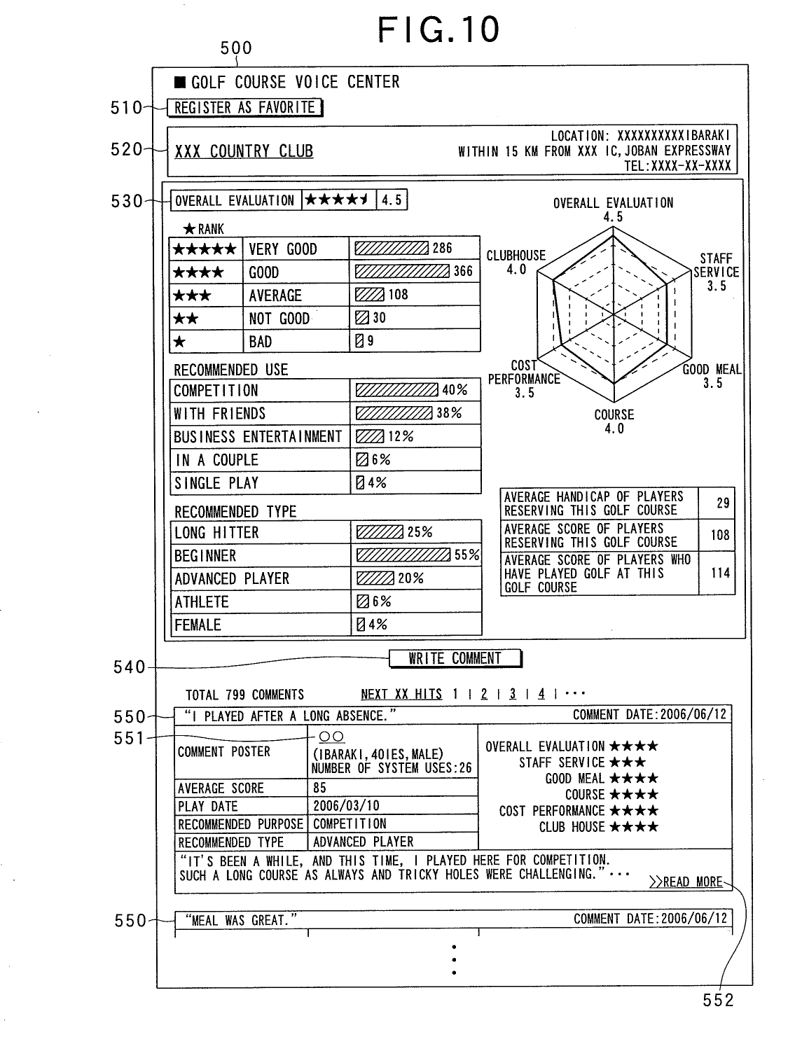

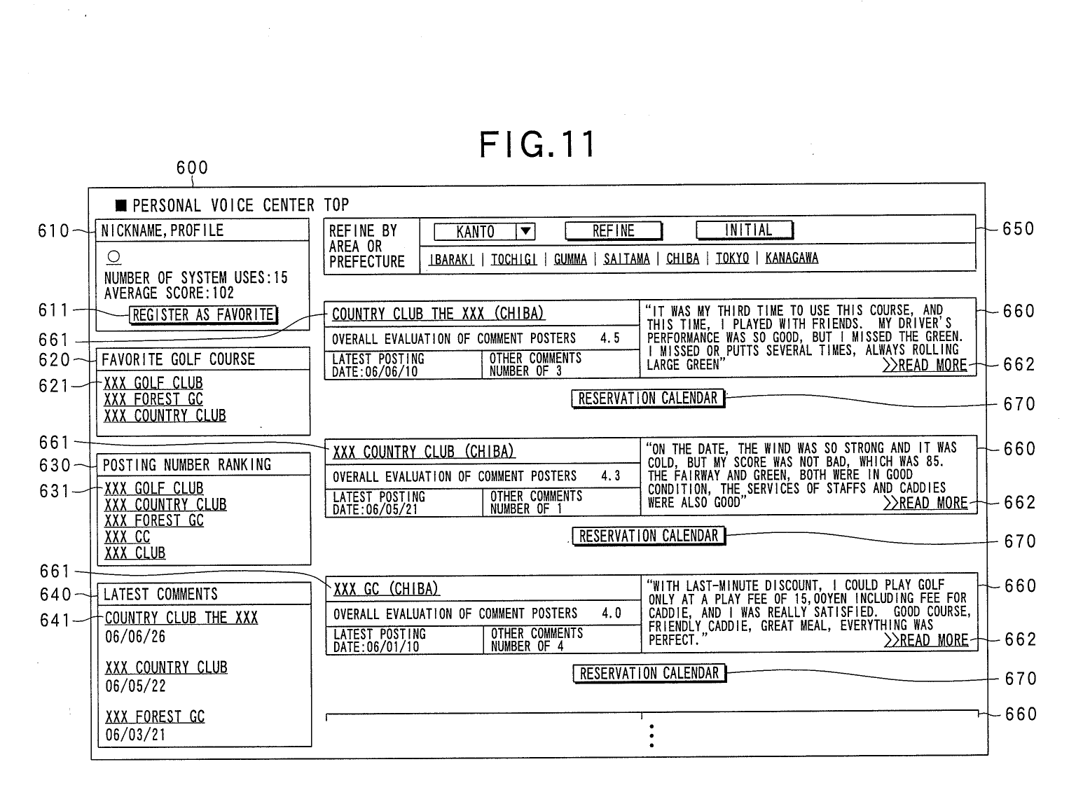

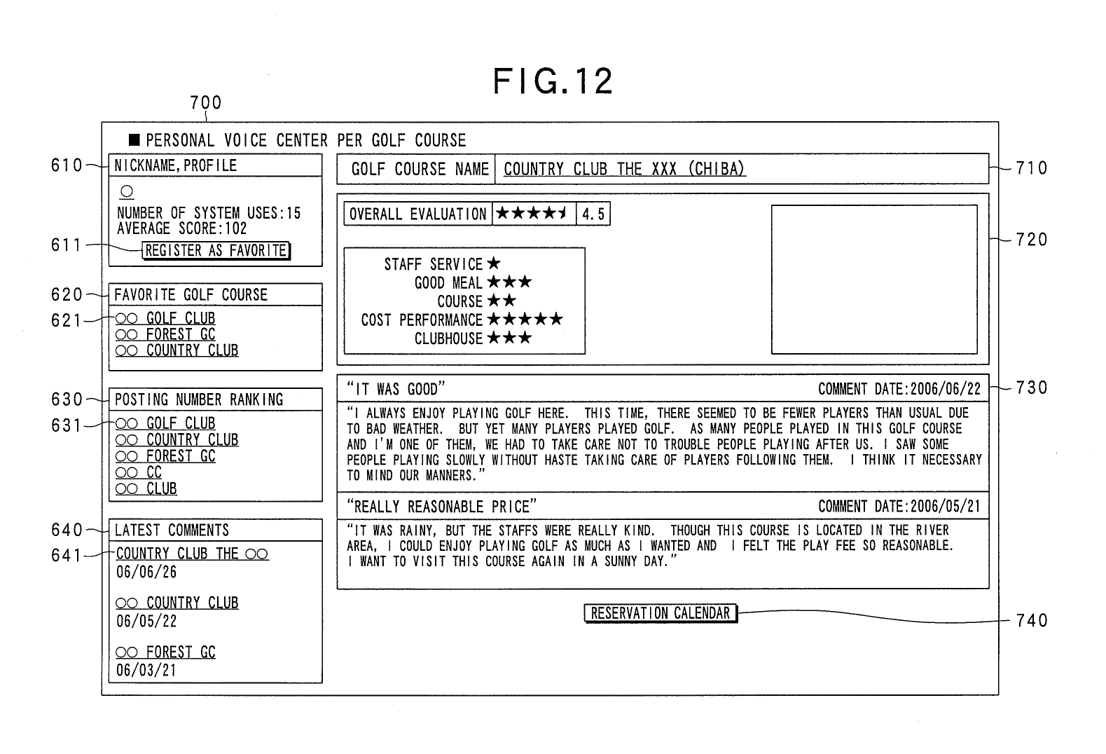

Here, the above-described voice center page includes, for example, a golf course voice center page 500 (see FIG. 10) for displaying comments on each golf course, a personal voice center top page 600 (see FIG. 11) for displaying comments and favorite golf courses of each member, a personal voice center golf course page 700 (see FIG. 12) for displaying comments on each golf course posted by members, and the like. HTML data constituting each of these pages is generated when comment management information and favorite information are registered and is stored in the storage part 15 in advance. The HTML data is, for example, identifiable by a path comprising a file name, a directory and the like, and this path is associated uniquely with a URL set in the request header when the user terminal 4-k requests the web page.

Further, the storage part 15 has stored therein, in addition to a predetermined operating system, a WWW (World Wide Web) server program for generating a web page based on various data stored in the storage part 15 in response to a request from the user terminal 4-k or the like using HTTP (Hyper Text Transfer Protocol) and sending the web page to the user terminal 4-k or the like, a mail server program for receiving an electronic mail sent from another mail server using a SMTP (Simple Mail Transfer Protocol) and sending to another mail server an electronic mail created in the golf course reservation server 1, a member information management program for managing member information of members of the golf course reservation system S with use of the member information database 101 and performing processing such as member registration, withdrawal (deletion of registration), change of member information, a golf course reservation management program for performing processing such as registration of golf course reservation, golf course search and the like, and a golf-related management program for performing processing of management of member's golf play history, score information, comment, favorite golf course information, ranking information and the like.

Here, each program or the like may, for example, be obtained from another service device or the like via a network NW, or stored in a disk DK such as a CD-ROM and read in therefrom via the drive part 14.

In this embodiment, the system controller 20 comprises an example of comment information receiving means, user identification information recognizing means, link information generating means, screen information generating means, screen information sending means, comment information registering means, favorite designation information receiving means, favorite information registering means, access request information receiving means, transaction object screen information sending means, transaction request receiving means, transaction registering means, transaction fixing recognizing means and reward information registering means.

In addition, the system controller 20 is configured to control each part of the golf course reservation server 1 by the CPU 17 reading and executing various programs stored in the ROM 18 or the storage part 15 and to function as each of above-described means.

Description is made about functions of each means. The system controller 20 is configured to perform log in processing for identifying a user of a user terminal 4-k accessing a golf course reservation site and receive a member ID from the user terminal 4-k. Specifically, the system controller 20 sends a log-in page to the user terminal 4-k in response to the log in request from the user terminal 4-k and receives from the user terminal 4-k the member ID and a password input by the user via the log in page. Then, the system controller 20 conducts password authentication based on the received member ID and password and member information registered in the member information database 101. When this password authentication ends successfully, the system controller 20, for example, generates a session ID which is identification information peculiar to each session and holds the session ID in association with the received member ID so as to maintain the connection state with use of session management or the like.

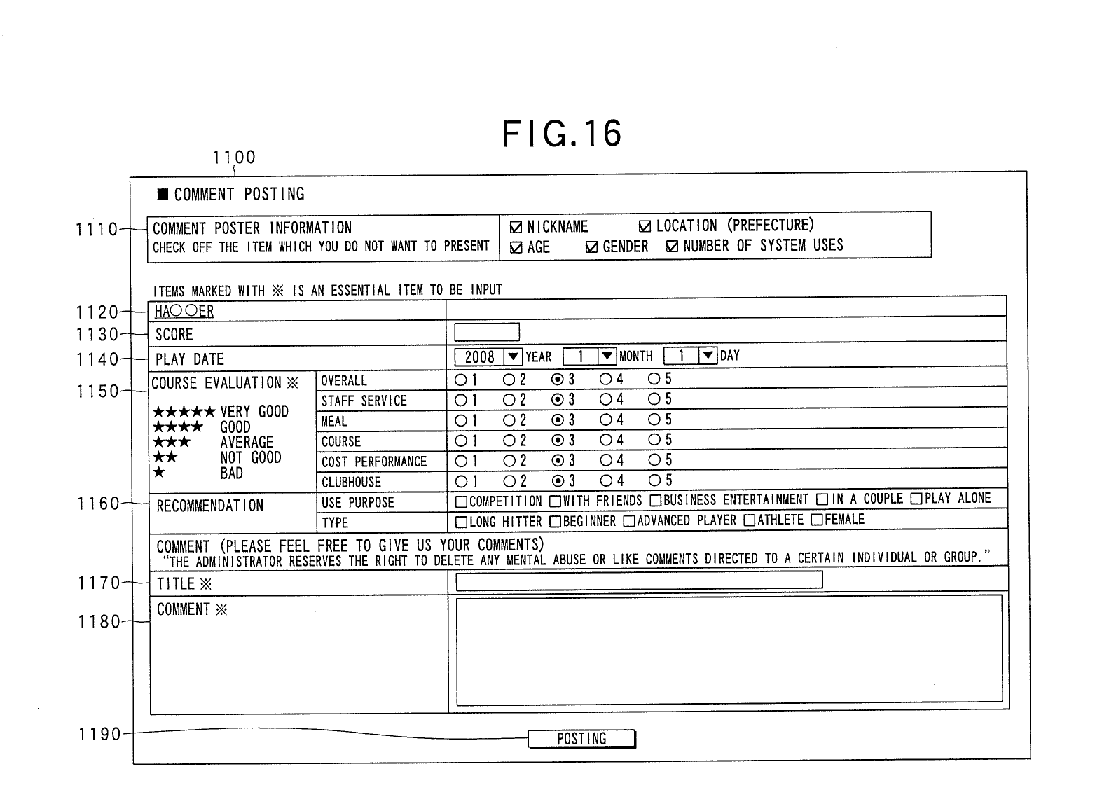

The system controller 20 as comment information receiving means is configured to, when a user inputs an average score, a play date, evaluation information, recommendation information, a comment title, a comment and the like via a later-described comment posting page 1100 (see FIG. 16), receive a comment registration request (with information input by the user) sent from the user terminal 4-k.

The system controller 20 as favorite designation information receiving means is configured to, when a user selects favorite registration via a later-described golf course voice center page 500 (see FIG. 10), receive a favorite golf course registration request (an example of favorite registration request information) with a golf course ID of the golf course designated as favorite.

Moreover, the system controller 20 as user identifying information recognizing means is configured to obtain the member ID held in the session management so as to identify a user who has posted the comment or a user who has designated the golf course as favorite.

In addition, the system controller 20 as comment information registering means is configured to, when receiving comment information or the like from a user terminal 4-k, generate comment management information (including a golf course ID of the commented golf course) based on the received information and register the comment management information in the member use information database 102 in association with the member ID.

Meanwhile, the system controller 20 as favorite information registering means is configured to, when receiving favorite registration request information from a user terminal 4-k, additionally register a golf course ID set in the favorite registration request information into the favorite golf course information registered in the member use information database 102 in association with the member ID.

In addition, the system controller 20 as link information generating means is configured to generate an affiliate URL associated with comment management information or favorite golf course information registered in the member use information database 102.

Specifically, when the system controller 20 generates an affiliate link associated with comment management information, the system controller 20 generates an affiliate URL having a URL showing a registered location of an affiliate control program for controlling an access via the affiliate link and a golf course ID and a member ID set in the comment management information (these IDs may be encrypted).

On the other hand, when the system controller 20 generates an affiliate link associated with favorite golf course information, the system controller 20 generates an affiliate URL having a URL showing a registered location of an affiliate control program and a golf course ID and a member ID set in the favorite golf course information (these IDs may be encrypted).

Here, since the affiliate URL only has to be able to specify a reservation page of a golf course indicated by the golf course ID set in the comment management information or the golf course ID set in the favorite golf course information, the affiliate link URL may have, in place of the URL showing the registered location of the affiliate control program and golf course ID, a URL directly showing a registered location of the reservation page of the golf course and this URL and the member ID may be used to generate the affiliate URL.

In addition, the system controller 20 as screen information generating means is configured to generate or renew a voice center page having the affiliate link set therein.

Specifically, when comment management information or favorite information is registered, the system controller 20 determines a voice center page to be generated or renewed according to this information. Then, when HTML data of the determined page is not generated yet, the system controller 20 newly generates the HTML data and when the HTML data is already generated, the system controller 20 renews the HTML data.

Here, when the comment management information is registered, the system controller 20 embeds in the target HTML data a title, a comment and the like set in the comment management information in a manner that they can be displayed. Next, for example, when the affiliate link is to be selected by a button, the system controller 20 generates a form tag, sets the generated URL in an action attribute of the tag, and inserts a submit tag in the form tag thereby to generate the affiliate link. Then, the system controller 20 embeds the generated affiliate link in the target HTML data in such a manner as to make the link displayed close to the corresponding comment.

On the other hand, when the favorite information is registered, the system controller 20 generates an anchor tag (<A></A>) and sets the generated affiliate URL in a href attribute of the tag. Next, the system controller 20 obtains a golf course name from the golf course information registered in the golf course database 104 in association with the golf course ID set in the favorite information, and inserts the golf course name in the anchor tag thereby to generate the affiliate link. Then, the system controller 20 embeds the generated affiliate link in the target HTML data.

In addition, the system controller 20 as screen information sending means is configured to send the voice center page generated in advance and stored in the storage part 15 to a user terminal 4-k in response to a request from the user terminal 4-k.

In addition, the system controller 20 as access request receiving means is configured to receive an access request (an example of access request information) sent from a user terminal 4-k when the user has selected the affiliate link via the voice center page.

Next, the system controller 20 as transaction object screen information sending means is configured to send a reservation page (an example of transaction object screen information) to a user terminal 4-k in response to the received access request. Specifically, when the system controller 20 obtains a URL set in a header of the access request and recognizes the affiliate link, it obtains from the URL a golf course ID and a member ID (member ID embedded in the affiliate link). Then, the system controller 20 is configured to send to the user terminal 4-k a reservation page of a golf course associated with the obtained golf course ID and an affiliate Cookie which is a Cookie indicating that the affiliate link is routed through (for example, having set therein a member ID obtained from the affiliate URL).

The system controller 20 as transaction request receiving means is configured to receive a reservation request (an example of transaction request information) sent from a user terminal 4-k when the user has selected a reservation via the reservation page. Then, when the affiliate Cookie sent together with the reservation page is set in the header of the reservation request, the system controller 20 is configured to obtain the member ID set in the Cookie.

Next, the system controller 20 as transaction registering means is configured to register member reservation information in the member use database 101 based on a reservation request. Then, when the system controller 20 obtains the member ID from the affiliate Cookie, the system controller 20 sets in the member reservation information the member ID obtained from the affiliate Cookie as affiliate information and reward points in accordance with a play fee or the like, and adds the reward points to temporary points in the member information corresponding to the member ID.

The system controller 20 as transaction fixing recognizing means and reward registering means is configured to recognize use of a golf course according to member reservation information as fixed when a play date set in the member reservation information has come and to change the reward points added to the temporary points of the member information corresponding to the member ID of the affiliate information set in the member reservation information into fixed points. Here, transition of the reward points to fixed points may be performed collectively on a monthly basis, for example, instead of performing every time when a user of a golf course is fixed.

The golf course reservation server 1 may include a plurality of server devices such as a reservation management server for performing processing concerning reservations such as registration of a reservation of a golf course, golf course search and the like based on information registered in various databases, a member information management server for managing member information registered in the member information database 101 and performing processing such as member registration, change of member information and the like, a golf related management server for performing processing such as management of play history, score information, comments and favorite golf course information, management of ranking information and the like, and a WWW server for providing various information as a golf course reservation site based on various information managed in the other servers.

### [3. Page Structures of My Page, Voice Center Page and the Like]

Next description is made about the page structures of the my page 300, the voice center page and the like provided (sent) from the golf course reservation server 1 to the user terminal 4-k, with reference to FIGS. 8 to 16.

### [3-1. My Page]

First, description is made about the page structure of the my page 300. FIG. 8 is a view showing a display example of the “my page” 300.

The my page 300 is a page for a member to check his information on golf in the golf course reservation system S and to register, change and delete the information, and is generated based on the member information, play history, score information, comment management information, favorite golf course information and the like associated with the member ID of the target user.

As shown in FIG. 8, the my page 300 includes a current point display area 310, a score basic information display area 320, a menu selection area 330, a play history display area 340 and a favorite golf course display area 350.

In the current point display area 310, user's fixed points are displayed.

In the score basic information display area 320, user's handicap, number of score registrations, best score, average score and the like calculated based on the score information previously registered by the user or the like are displayed.

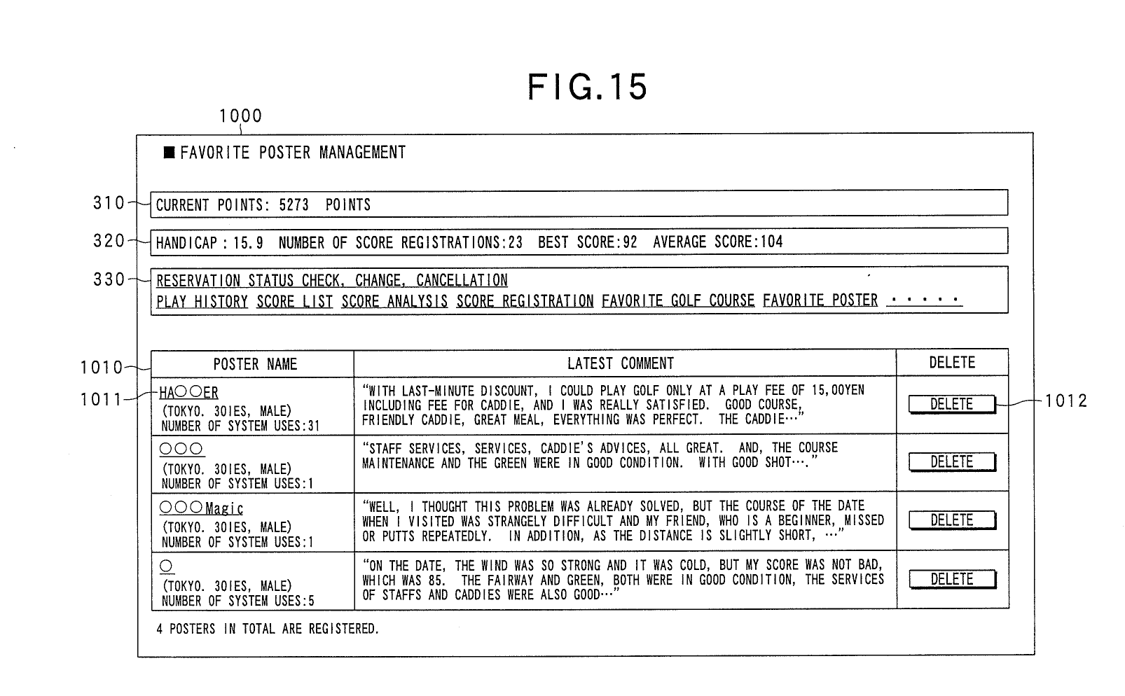

In the menu selection area 330, links for moving to pages for various procedures or pages for checking various information are displayed. Here, when the favorite poster link is selected, a later-described favorite poster management page 1000 (see FIG. 15) is displayed.

In the play history display area 340, a recent play history of, for example, two plays is displayed based on the play history registered in the member use information database 102. In each play history, for example, play date, played golf course name link 342, number of groups and players, accompanying players' names, weather and wind strength, score, user's rank in overall category of competitions (e.g., prize of the month) where the user has attended and the number of entries, evaluations and comments on the golf course by the user are displayed.

When a comment number is given in the play history registered in the member use information database 102, necessary information is obtained from comment management information registered in association with the comment number and embedded in the HTML data. When no comment number is given in the play history, the comment posting link 341 is embedded in the HTML data.

Here, when the user selects the comment posting link 341, a later-described comment posting page 1100 (see FIG. 16) for posting comments is displayed. When the golf course name link 342 is selected, a course guide page showing course information of the golf course indicated by the golf course name is displayed. Further, when the score link 343 is selected, a page showing score check and the like is displayed. Furthermore, when the competition link 344 is selected, a competition ranking page is displayed. Here, if the score information is not registered, the score and user rank and the like are not displayed.

When the user selects the play history list link 345, a play history list page showing all play histories (display contents are the same as those in the play history display area 340) is displayed.

When the user posts a comment via the play history display area 340 or the play history list page, an affiliate link associated with the comment is generated. In other words, when the user makes a reservation and posts a comment on the used golf course, the affiliate link is generated.

In the favorite golf course display area 350, a golf course name link 351, a location, a nearby interchange, a service plan, a reservation calendar button 352 (not an affiliate link), a course guide button 353, a comment writing link 354, the number of plays, and an average score (average gross, number of score registration, average number of putts, average number of OBs) of each of favorite-registered golf courses are displayed.

Here, when the user selects a golf course name link 351 or a course guide button 353, a course guide page of the corresponding golf course is displayed. Further, when a reservation calendar button 352 is selected, a reservation page is displayed. Further, when a comment writing link 354 is selected, the comment posting page 1100 is displayed.

When the user selects the favorite golf course list link 355, the favorite golf course list display page showing all favorite golf courses (the same contents as those in the favorite golf course display area 350 are displayed) is displayed.

Here, even if the user posts a comment via the favorite golf course display area 350 or the favorite golf course list page, no affiliate link is generated and a normal link is generated for moving to the reservation page.

### [3-2. Voice Center Top Page]

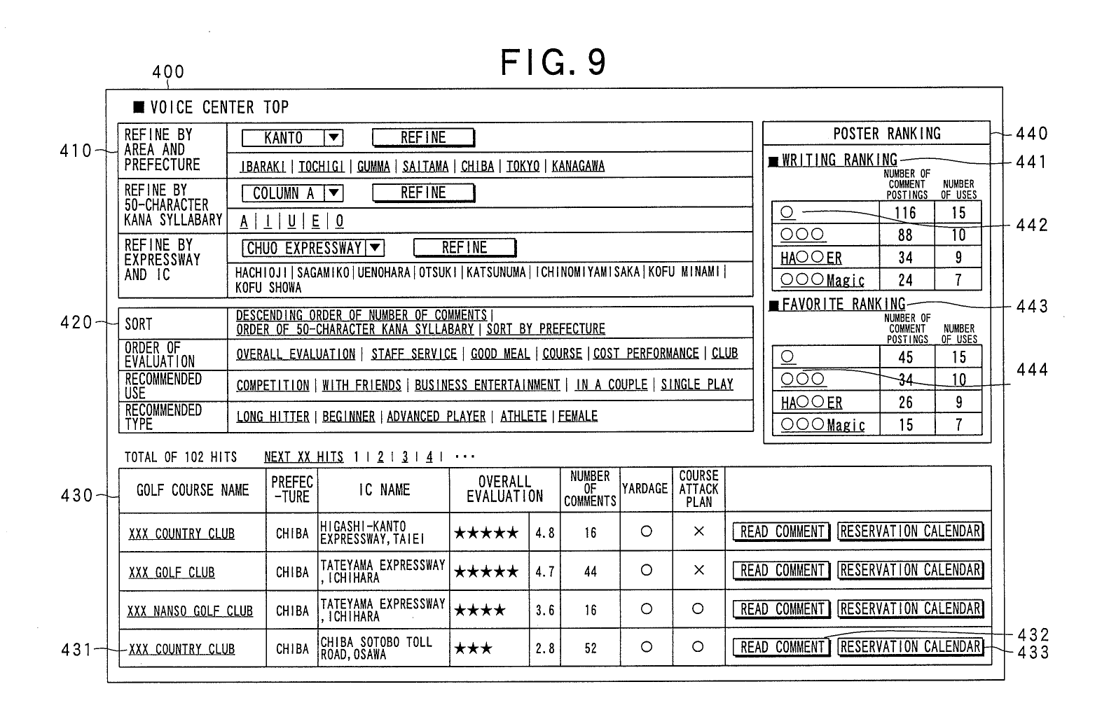

Next description is made about the page structure of a voice center top page 400 which is a top page of the voice center. FIG. 9 is a view showing a display example of the voice center top page 400.

The voice center top page 400 is a page generated based on golf course data, comment writing number ranking information, favorite poster ranking information and the like.

As shown in FIG. 9. the voice center top page 400 includes a refining selection area 410, a sorting selection area 420, a golf course list display area 430 and a poster ranking display area 440.

In the refining selection area 410, pull-down menus, buttons, links and the like are displayed for selecting refining criteria to refine golf courses to be displayed in the golf course list display area 430 (refining is allowed as to prefecture, first letter of name, expressway, interchange and the like).

In the sorting selection area 420, links or the like for selecting criteria for determining the listing order of golf courses to be displayed in the golf course list display area 430 are displayed.

In the golf course list display area 430, a list of golf courses is displayed based on selection of refining criteria in the refining selection area 410 and selection of sorting criteria in the sorting selection area 420. Specifically, in the golf course list display area 430, a golf course name link 431, a location, a nearby interchange, a golf course's overall evaluation, the number of posted comments, presence or absence of yardage and course rate registration, presence or absence of registration of course attack plan, a comment reading button 432 and a reservation calendar button 433 of each golf course are displayed.

Here, when a user selects a golf course name button 431 or a comment reading button 432, a later-described golf course voice center page 500 (see FIG. 10) of the corresponding golf course is displayed. When a reservation calendar button 433 is selected, a reservation page of the corresponding golf course is displayed.

In the poster ranking display area 440, top-ranked persons in the comment writing ranking and favorite poster ranking are displayed. HTML data associated with the poster ranking display area 440 is generated based on the comment writing number ranking information and favorite poster ranking information registered in the ranking information database 103.

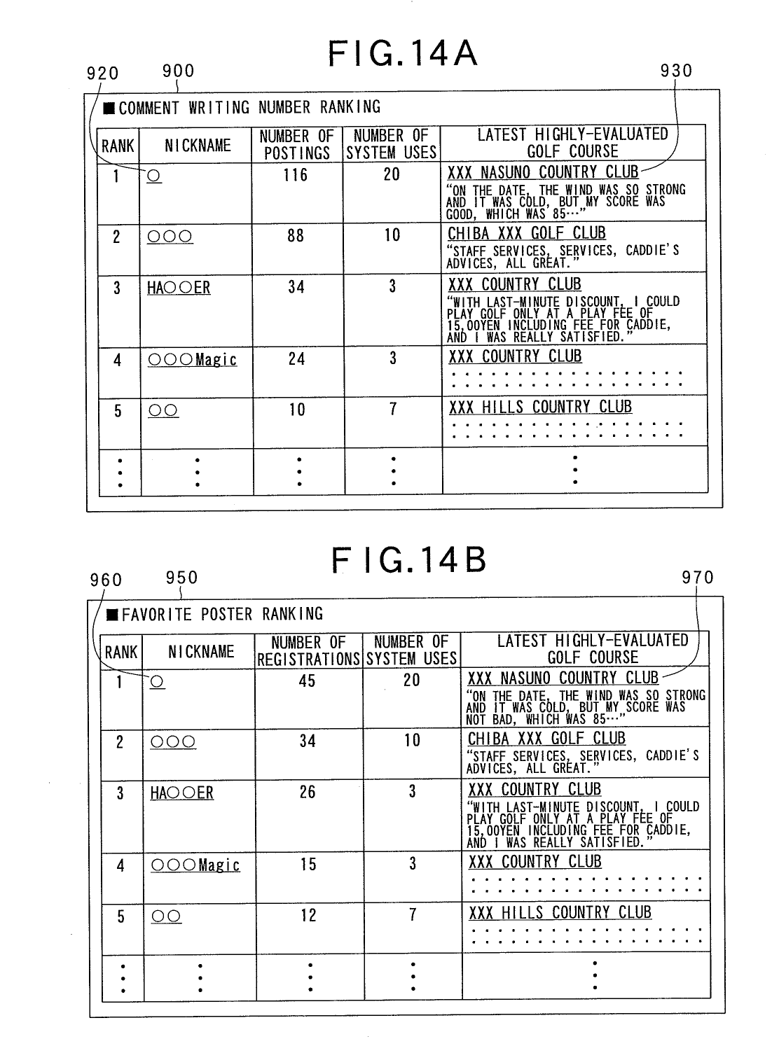

Here, when a user selects the writing ranking link 441, a later-described comment writing number ranking page 900 (see FIG. 14(a)) is displayed. When a comment poster nickname link 442 is selected, a later-described personal voice center top page 600 (see FIG. 11) of the corresponding comment poster is displayed. Further, when the favorite ranking link 443 is selected, a later-described favorite poster ranking page 950 (see FIG. 14(b)) is displayed. Furthermore, when a comment poster nickname link 444 is selected, the personal voice center top page 600 of the corresponding comment poster is displayed.

### [3-3. Golf Course Voice Center Page]

Next description is made about the page structure of the golf course voice center page 500. FIG. 10 is a view showing a display example of the golf course voice center page 500.

The golf course voice center page 500 is a page for reading comments and evaluations on a designated golf course and is generated based on the golf course information associated with a golf course ID of the target golf course, comment management information having set therein the golf course ID of the target golf course among the comment management information and the like.

In addition, the golf course voice center page 500 is, for example, a page which is displayed when a golf course name link 431 or a comment reading button 432 is selected in the voice center top page 400 or when a golf course name link 711 is selected in a personal voice center golf course page 700 described later (see FIG. 12).

As shown in FIG. 10, the golf course voice center page 500 includes a favorite registration button 510, a golf course data display area 520, an evaluation statistical display area 530, a comment posting button 540 and one or more comment display areas 550.

In the golf course data display area 520, a golf course name, a location, a nearby interchange, a telephone number and the like are displayed.

In the evaluation statistical display area 530, latest statistics of, for example, the past six months are displayed as to evaluations, recommended purpose, recommended type and the like input by the comment posters via the comment posting page 1100 described later (see FIG. 16).

In the comment display area 550, a title of the posted comment, a posting date, information of the comment poster, recommended purpose, recommended type, evaluations, excerpt from the comment and the like are displayed. A plurality of comment display areas 550 is displayed, for example, in chronological order of posting date beginning with the latest one.

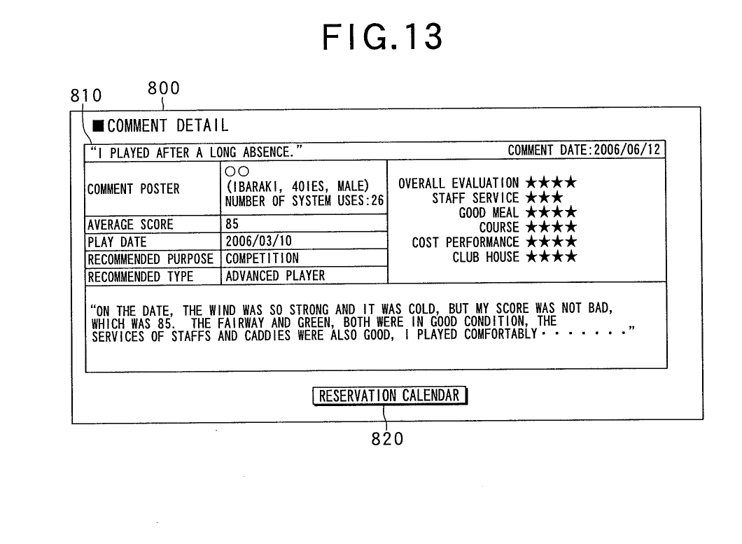

Here, when the user selects the comment poster nickname link 551, the later-described personal voice center top page 600 (see FIG. 11) of the corresponding comment poster is displayed. When the detail link 552 is selected, the later-described comment detail page 800 for displaying the entire comment (see FIG. 13) is displayed.

When the user selects the favorite registration button 510, a golf course displayed on the current golf course voice center page 500 is registered as the user's favorite golf course. When the user selects the comment posting button 540, the comment posting page 1100 is displayed. Even if a comment is posted via this comment posting button 540, no affiliate link is generated and a normal link for moving to a reservation page is generated.

### [3-4. Personal Voice Center Top Page]

Next description is made about the page structure of the personal voice center top page 600. FIG. 11 is a view showing a display example of the personal voice center top page 600.

The personal voice center top page 600 is a page for displaying comments or the like of a designated comment poster to be read by other users, and is generated based on member information corresponding to a member ID of the designated comment poster, comment management information, favorite golf course information and the like.

The personal voice center top page 600 is, for example, a page which is displayed when a comment poster nickname link is selected in the voice center top page 400 (see FIG. 9), the golf course voice center page 500 (see FIG. 11), the comment writing number ranking page 900 (see FIG. 14(a)), the favorite poster ranking page 950 (see FIG. 14(b)) or the favorite poster management page 1000 (see FIG. 15).

As shown in FIG. 11, the personal voice center top page 600 includes a comment poster profile display area 610, a favorite golf course display area 620, a posting number ranking display area 630, a latest posting display area 640, a refining selection area 650, one or more comment display areas 660 and reservation calendar buttons 670.

In the comment poster profile display area 610, a comment poster's nickname, the number of reservations made via the golf course reservation system S, an average score and a favorite registration button 611 are displayed.

When the user selects the favorite registration button 611, a target comment poster is registered as favorite poster.

In the favorite golf course display area 620, golf course name links 621 of golf courses registered as favorite by the comment poster are displayed. When the user selects a golf course name link 621, the reservation page of the golf course indicated by the golf course name is displayed. This golf course name link 621 is an affiliate link having an affiliate URL embedded therein in association with the link. In other words, when another user views the personal voice center top page 600 and makes a reservation by clicking on this affiliate URL, the comment poster of this personal voice center top page 600 (user who has registered the golf course as favorite) can be given an affiliate reward.

In the posting number ranking display area 630, a golf course name link 631 of a golf course on which many comments are posted by comment posters. When the user selects the golf course name link 631, the later-described personal voice center golf course page 700 (see FIG. 12) of the golf course indicated by the golf course name is displayed.

In the latest posting display area 640, golf course name links 641 of golf courses recently commented by the comment poster is displayed. When the user selects a golf course name link 641, the personal voice center golf course page 700 of the golf course indicated by the golf course name is displayed.

In the refining selection area 650, a pull-down menu, a button, links and the like for selecting golf courses of which comments are shown in the comment display areas 660 by refining with location are displayed.

In the comment display areas 660, out of comments posted by the comment poster, excerpts of latest comments of the golf courses that meet refining criteria in the refining selection area 650 are displayed.

When the user selects a golf course name link 661, the personal voice center golf course page 700 of the golf course indicated by the golf course name is displayed. When a detail link 662 is selected, then, the later-descried comment detail page 800 (see FIG. 13) is displayed.

Each reservation calendar button 670 is arranged in association with its corresponding comment display area 660. When the user selects a calendar button 670, a reservation page of the golf course displayed in the corresponding comment display area 660 is displayed. This calendar button 670 is an affiliate link having an affiliate URL embedded therein in association with the button. In other words, when another user views the personal voice center top page 600 and makes a reservation by clicking on the affiliate URL, the comment poster of the personal voice center top page 600 can be given an affiliate reward.

### [3-5. Personal Voice Center Golf Course Page]

Next description is made about the page structure of the personal voice center golf course page 700. FIG. 12 is a view showing a display example of the personal voice center golf course page 700, in which the same elements as those in the FIG. 11 are assigned with the same reference numerals.

The personal voice center golf course page 700 is a page for displaying comments or the like on a further designated golf course out of comments posted by a designated comment poster so that another user can read them, and is generated based on the member information associated with a member ID of the designated comment poster, comment management information (having set therein the golf course ID of the designated golf course), favorite golf course information and the like.

Further, the personal voice center golf course page 700 is a page which is displayed when a golf course name link 631, 641 or 661 is selected in the personal voice center top page 600 or the personal voice center golf course page 700, or when a golf course name link is selected in the later-described comment writing number ranking page 900 or favorite poster ranking page 950.

As shown in FIG. 12, the personal voice center golf course page 700 includes a comment poster profile display area 610, a favorite golf course display area 620, a posting number ranking display area 630, a latest posting display area 640, a golf course name display area 710, an evaluation display area 720, a comment display area 730 and a reservation calendar button 740.

In the golf course name display area 710, a golf course name is displayed.

In the evaluation display area 720, out of evaluations registered with comments by the comment poster, for example, an evaluation average of past 6 months is displayed, and a course picture of the golf course is displayed.

In the comment display area 730, information (title, posting date and comment) on all comments posted on the target golf course by the comment poster is displayed in chronological order of posting date beginning with the latest one.

When the user selects the reservation calendar button 740, the reservation page of the commented golf course is displayed. This calendar button 740 is an affiliate link having an affiliate URL embedded therein in association with the button.

### [3-6. Comment Detail Page]

Next description is made about the page structure of the comment detail page 800. FIG. 13 is a view showing a display example of the comment detail page 800.

The comment detail page 800 is a page for displaying a designated comment entirely and is generated based on corresponding comment management information, member information corresponding to a member ID set in the comment management information and the like.

In addition, the comment detail page 800 is a page which is displayed, for example, when the detail button is selected in the golf course voice center page 500 or the personal voice center top page 600.

As shown in FIG. 13, the comment detail page 800 includes a comment display area 810 and a reservation calendar button 820.

In the comment display area 810, a title of a posted comment, a posting date, information on the comment poster, recommended purpose, recommended type, evaluations and comment are displayed.

When the user selects the calendar button 820, a reservation page of the commented golf course is displayed. This calendar button 820 is also an affiliate link, in which an affiliate URL is embedded in association with the button.

### [3-7. Comment Writing Number Ranking Page]

Next description is made about the page configuration of the comment writing number ranking page 900. FIG. 14A is a view showing a display example of the comment writing number ranking page 900.

The comment writing number ranking page 900 is a page for displaying comment posters ranked based on the number of comments on golf courses. This page is generated based on comment writing number ranking information, comment management information corresponding to member IDs of ranked comment posters and the like.

In addition, the comment writing number ranking page 900 is a page which is displayed, for example, when the writing ranking link 441 is selected in the voice center top page 400.

As shown in FIG. 14A, in the comment writing number ranking page 900, ranks, comment poster nickname links 920, numbers of postings, numbers of system uses, golf course name links of latest highly-evaluated golf courses 930 and comments are displayed in the order of decreasing number of comment postings.

Here, when a user selects a comment poster nickname link 920, the personal voice center top page 600 of the comment poster indicated by the nickname is displayed. When a golf course name link 930 is selected, the personal voice center golf course page 700 of the corresponding comment poster concerning the golf course indicated by the golf course name is displayed.

### [3-8. Favorite Poster Ranking Page]

Next description is made about the page structure of the favorite poster ranking page 950. FIG. 14(b) is a view showing a display example of the favorite poster ranking page 950.

The favorite poster ranking page 950 is a page for displaying comment posters ranked based on the number of registrations as favorite poster and is generated based on favorite poster ranking information, comment management information corresponding to member IDs of ranked comment posters and the like.

In addition, the favorite poster ranking page 950 is a page which is displayed, for example, when the favorite ranking link 443 is selected in the voice center top page 400.

As shown in FIG. 14B in the favorite poster ranking page 950, ranks, comment poster nickname links 960, numbers of registrations, numbers of system uses, golf course name links 970 of the latest highly-evaluated golf courses and comments are displayed in the order of decreasing number of registrations as favorite poster.

Here, when the user selects a comment poster nickname link 960, the personal voice center top page 600 of the comment poster indicated by the nickname is displayed. When a golf course name link 970 is selected, the personal voice center golf page 700 of the comment poster associated with the golf course indicated by the golf course name is displayed.

### [3-9. Favorite Poster Management Page]

Next description is made about the page structure of the favorite poster management page 1000. FIG. 15 is a view showing a display example of the favorite poster management page 1000, in which the same elements as those in FIG. 8 are assigned with the same reference numerals.

The favorite poster management page 1000 is information for viewing and deleting a comment poster registered as favorite poster and is generated based on member information corresponding to a target user member ID, score information, favorite poster information, member information corresponding to a member ID of the comment poster set in the favorite poster information, comment management information and the like.

In addition, the favorite poster management page 1000 is a page which is displayed, for example, when a favorite poster link of the menu selection area 330 in the my page 300 is selected.

As shown in FIG. 15, the favorite poster management page 1000 includes a current point display area 310, a score basic information display area 320, a menu selection area 330 and a favorite poster display area 1010.

In the favorite poster display area 1010, information on comment posters registered in the favorite (nickname, location, age, gender, number of system uses), latest comments posted by the comment posters, and delete buttons 1012 are displayed.

Here, when a user selects a comment poster nickname link 1011, the personal voice center top page 600 of the comment poster indicated by the nickname is displayed. When a delete button 1012 is selected, the corresponding comment poster is deleted from favorite posters list.

### [3-10. Comment Posting Page]

Next description is made about a page structure of the comment posting page 1100. FIG. 16 is a view showing a display example of the comment posting page 1100.

The comment posting page 1100 is a page for entry of comments, evaluations and the like on the golf courses.

In addition, the comment posting page 1100 is a page displayed when the comment posting link 341 is selected in the my page 300 or when the comment posting button 540 is selected in the golf course voice center page 500.

Here, when a user moves from the my page 300 to post a comment, an affiliate link associated with the comment is generated (that is, when a comment associated with reservation or play is posted, the affiliate link is generated), while when a user moves from the golf course voice center page 500 to post a comment, the affiliate link associated with the comment is not generated (that is, when a comment not associated with reservation or play is posted, the affiliate link is not generated).

As shown in FIG. 15, the comment posting page 1100 includes a comment poster information display selection area 1110, a comment poster name display area 1120, a score input area 1130, a play date selection area 1140, an evaluation selection area 1150, a recommendation selection area 1160, a title input area 1170, a comment input area 1180 and a posting button 1190.

In the comment poster information display selection area 1110, check boxes are displayed for selecting whether each item of comment poster information is posted or not when a comment is posted in the voice center page.

In the comment poster name display area 1120, a nickname of the user who posts a comment is displayed.

In the score input area 1130, an input form for inputting a score when a user has played in the commented golf course is displayed. In the play date selection area 1140, pull-down menus for selecting a play date are displayed.

In the evaluation selection area 1150, radio buttons for selecting an evaluation on a golf course on a five-point scale for each index are displayed. In the recommendation selection area 1160, check boxes for selecting a recommended use purpose or player type are displayed.

In the title input area 1170, an input form for inputting a comment title is displayed. In the comment input area 1180, an input form for inputting a comment body text is displayed.

When a user selects the posting button 1190, the contents input and selected by the user in the comment posting page 1100 are registered in the member use database 102 as comment management information.

### [4. Operation of Golf Course Reservation System]

Next description is made about the operation of the golf course reservation system S.

### [4-1. Operation Outline]

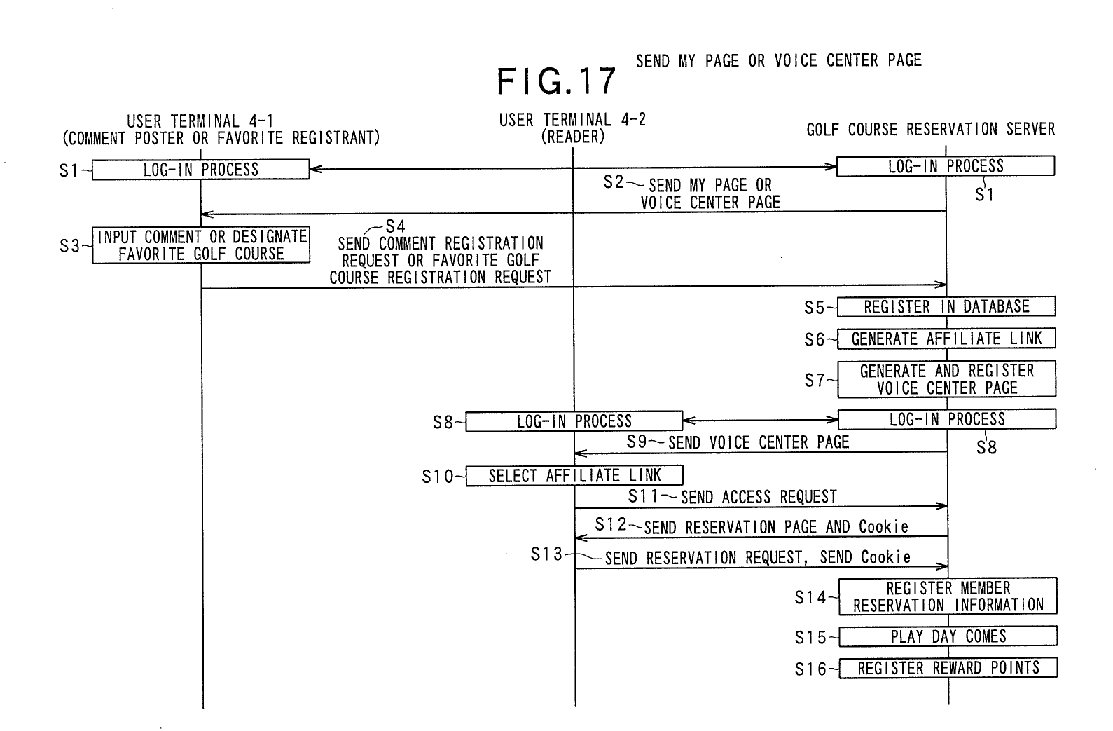

First, description is made on the operation outline of the overall golf course reservation system S conducted while comment posting and registration of favorite golf courses are performed, a reservation is made via an affiliate link thereafter, and reward points given to a comment poster or favorite registrant are fixed, with reference to FIG. 17.

FIG. 17 is a sequence diagram showing an example of a processing flow in the golf course reservation system S according to the present embodiment.

Here, of the two user terminals 4-k described in the following description, a terminal device used by a comment poster or a favorite registrant is referred to as a user terminal 4-1 and a terminal device used by a reader who reads or views posted comments and registered favorite golf courses is referred to as a user terminal 4-2.

First, in response to a login request sent from the user terminal 4-1 to the golf course reservation server 1, as shown in FIG. 17, login processing is performed between the user terminal 4-1 and the golf course reservation server 1 (step S1). Specifically, a login page is sent from the golf course reservation server 1 to the user terminal 4-1, and a member ID and a password input by a comment poster or a favorite registrant via the login page are sent from the user terminal 4-1 to the golf course reservation server 1. Then, password authentication is performed in the golf course reservation server 1. When the password authentication is finished successfully, the received member ID is held by the received session management.

Next, in response to a request from the user terminal 4-1, the golf course reservation server 1 sends the user terminal 4-1 a my page 300 or a voice center page (step S2), and the my page 300 is displayed on screen at the user terminal 4-1.

When the comment poster or favorite registrant operates the user terminal 4-1, to designate a golf course, and enter a comment or to designate a golf course which he wants to register as favorite (step S3), the user terminal 4-1 sends the golf course reservation server 1 a comment registration request or a favorite golf course registration request (step S4).

Once the golf course reservation server 1 receives the request, it registers in the member use information database 102 the comment management information or favorite golf course information based on the request in association with the member ID held in the session management (step S5).

Then, the golf course reservation server 1 generates an affiliate link based on the registered comment management information or favorite golf course information, the member ID and the golf course ID associated with the information (step S6).

The golf course reservation server 1 then generates a voice center page where information such as comment set in the registered comment management information and the favorite golf course information are to be posted, embeds the information to post and the affiliate link in the page and registers them in the storage part 15. The processing is finished here for the meantime (step S7).

Thereafter, in response to a login request sent from the user terminal 4-2 to the golf course reservation server 1, login processing is performed between the user terminal 4-2 and the golf course reservation server 1 (step S8).

Next, in response to the request from the user terminal 4-1, the golf course reservation server 1 sends the user terminal 4-2 a voice center page (step S9), and the voice center page is displayed on screen at the user terminal 4-2.

Then, when the reader reads the comments and favorite golf courses of the user of the user terminal 4-1 and selects a reservation calendar or a link associated with a golf course which he wants to reserve (commented golf course or favorite golf course) (step S10), the user terminal 4-2 sends the golf course reservation server 1 an access request with an affiliate URL associated with the selected reservation button or link set in the request header (step S11).

Receiving the access request, the golf course reservation server 1 obtains the golf course ID and the member ID from the URL set in the request header, sends the user terminal 4-2 the reservation page associated with the golf course ID and also sends the user terminal 4-2 an affiliate Cookie (step S12).

The user terminal 4-2 displays the received reservation page on the screen and stores the affiliate Cookie. When the user operates to select a reservation button or the like, the user terminal 4-2 sends the golf course reservation server 1 a reservation request and also sends the golf course reservation server 1 the stored affiliate Cookie (step S13).

Receiving the reservation request and the affiliate Cookie, the golf course reservation server 1 sets affiliate information in the member reservation information based on the affiliate Cookie and registers the member reservation information in the member use information database 102. At this point, the processing is finished again for the meantime (step S14). This registration of the member reservation information means completion of the golf course reservation.

Later, as according to the registered member reservation information, when the reserved play day comes, the golf course reservation server 1 recognizes that the use of the golf course based on the reservation is fixed (step S15).

Then, the golf course reservation server 1 adds the reward points given to the user of the user terminal 4-1 as fixed points to the points in the member information of the user and renews the fixed points based on the affiliate information set in the member reservation information (step S16).

### [4-2. Operation of Comment Posting]

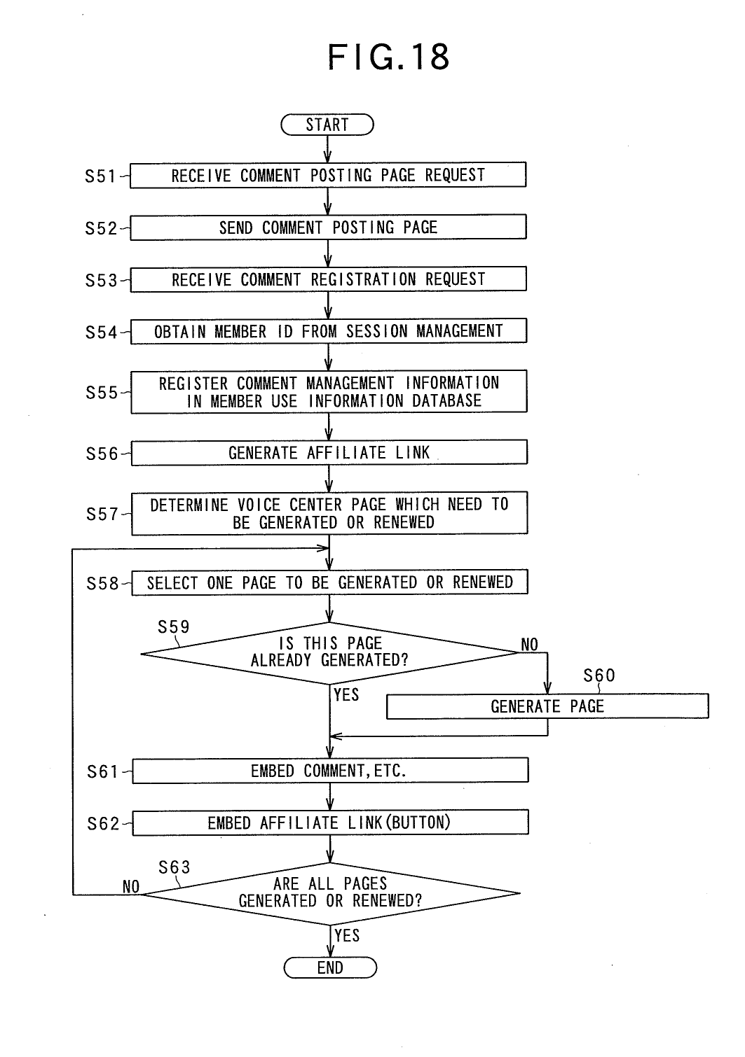

Next description is made about the operation of posting comments (steps S3 to S7 in FIG. 17), with reference to FIG. 18.

FIG. 18 is a flow chart showing an example of a processing flow in the comment registration processing performed by the system controller 20 of the golf course reservation server 1 according to the present embodiment.

A user uses a user terminal 4-k to log in to the golf course reservation system S, and the my page 300 (see FIG. 8) or the play history list page of the user is displayed on the screen of the user terminal 4-k.

Here, when the user selects a comment posting link of a golf course on which he wants to comment among the comment posting links displayed on the screen, the user terminal 4-k sends the golf course reservation server 1 a comment posting page request having set therein a golf course ID of the selected golf course.

Then, the system controller 20 of the golf course reservation server 1 receives the comment posting page request as shown in FIG. 18 (step S51), and sends the user terminal 4-k the comment posting page 1100 (see FIG. 16) (step S52).

When receiving the comment posting page 1100, the user terminal 4-k displays the page on the screen. Here, when the user operates the user terminal 4-k to at least select an evaluation on the golf course, enter a title of the comment and comment text on the golf course and selects the comment posting button 1190, the user terminal 4-k sends the golf course reservation server 1 a comment registration request having set therein the selected or input contents in the page.

Receiving the comment registration request (step S53), the system controller 20 of the golf course reservation server 1 obtains a member ID of the user from the session management (step S54), and registers the comment management information in the member use information database 102 (step S55). Specifically, the system controller 20 generates the comment management information based on the contents set in the comment registration request. Then, the system controller 20 newly assigns a comment number and set it in the comment management information and sets the date of today as a posting date. In addition, the system controller 20 sets the member ID obtained from the session management and the golf course ID set in the comment posting page request in the comment management information. Further, the system controller 20 sets “yes” in the presence or absence of history in the comment management information and sets a history ID of the corresponding play history. Finally, the system controller 20 registers the comment management information in association with the member ID obtained from the session management.

Then, the system controller 20 generates an affiliate link (step S56). Specifically, the system controller 20 generates an URL showing registered location of the affiliate control program and an affiliate URL having the golf course ID and the member ID set in the comment management information. Then, the system controller 20 generates a form tag, sets the generated URLs in an action attribute of the tag and further inserts a submit tag in the form tag thereby to generate the affiliate link.

Next, the system controller 20 determines a voice center page which needs to be generated or renewed according to the registered comment management information (step S57). Specifically, the system controller 20 determines that the personal voice center top page 600 (page associated with the member ID, see FIG. 11), the personal voice center golf course page 700 (page associated with the member ID and the golf course ID, see FIG. 12) and the comment detail page (page associated with the member ID, see FIG. 13), on which the comment is to be posted and in which the affiliate link is to be set, are the pages to be generated or renewed.

Then, the system controller 20 specifies one page from the voice center pages to be generated or renewed (step S58).

Next, the system controller 20 determines whether the specified page is already generated or not by referring to the storage part 15 (step S59). When the page is already generated (step S59, YES), the process goes to step S61.

On the other hand, when the specified page is not generated yet (step S59, NO), the system controller 20 generates the page (step S60). Specifically, the system controller 20, for example, obtains HTML data, which is an original form, stored in advance in the storage part 15 according to the type of the specified page, analyzes this HTML data, obtains necessary data from various databases to embed in the HTML data. Then, the system controller 20 generates the specified page and the process goes to step S61.

In step S61, the system controller 20 embeds information such as a comment offset in the comment management information at a predetermined position in the HTML data of the specified page.

Then, the system controller 20 embeds the generated affiliate link in a corresponding position close to the position where the comment or the like is embedded (step S62).

Thus, when generation or renewal of a page is finished, the system controller 20 determines whether or not generation or renewal is finished as to all of voice center pages which need to be generated or renewed (step S63). When there exists any voice center page which still needs to be generated or renewed (step S63, NO), the process goes to step S58 so that the page is generated or renewed. When there is no voice center page that needs to be generated or renewed (step S63, YES), the processing ends.

Here, after this processing, the system controller 20 generates or renews pages in which the affiliate link need not be set (for example, my page 300, golf course voice center page 500, etc.).

### [4-3. Operation in Favorite Golf Course Registration]

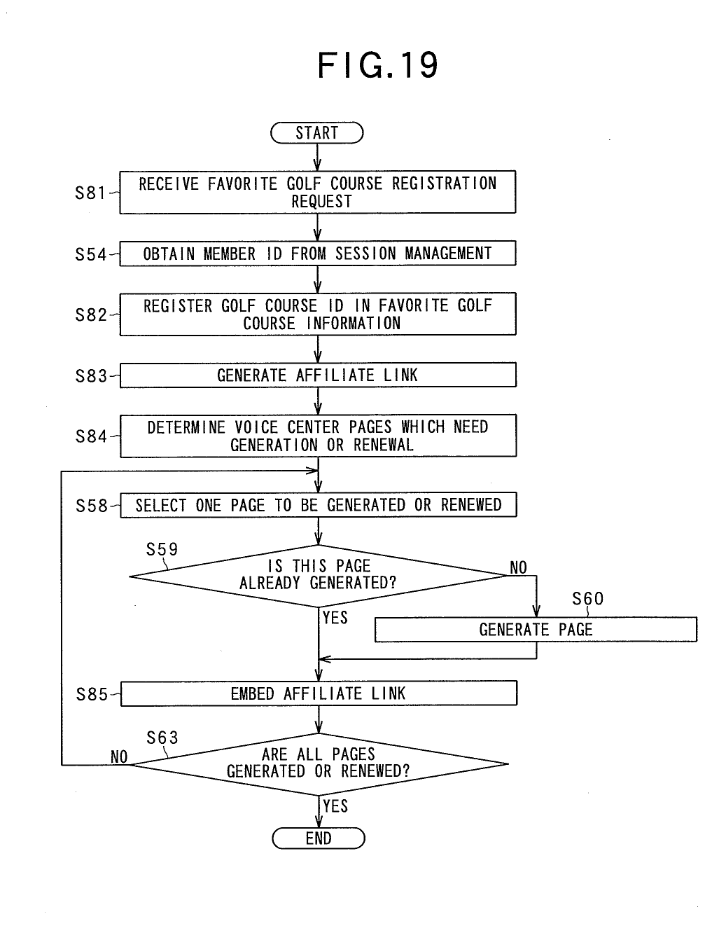

Next description is made about the operation of registering favorite golf courses (steps S3 to S7 in FIG. 17), with reference to FIG. 19.

FIG. 19 is a flow chart showing an example of a processing flow in the favorite golf course registration processing performed by the system controller 20 of the golf course reservation server 1 according to the present embodiment. In this figure, same elements as those in FIG. 18 are assigned with the same reference numerals.

A user logs in to the golf course reservation system S using a user terminal 4-k. On the screen of the user terminal 4-k, a golf course voice center page 500 (see FIG. 10) is displayed.

When the user selects the favorite registration button 510 displayed on the screen, the user terminal 4-k sends the golf course reservation server 1 a favorite golf course registration request having set therein a golf course ID of the selected golf course.

Then, the system controller 20 of the golf course reservation server 1, as shown in FIG. 18, receives the favorite golf course registration request (step S81) and obtains the member ID of the user from the session management (step S54).

Next, the system controller 20 additionally registers the golf course ID set in the favorite golf course registration request in favorite golf course information registered in the member use information database 102 in association with the obtained member ID (step S82).

Then, the system controller 20 generates an affiliate link (step S83). Specifically, the system controller 20 generates the affiliate URL similarly to the case of comment posting (see FIG. 18) and generates an anchor tag to set the generated affiliate URL in a href attribute of the tag. Finally, the system controller 20 obtains the golf course name from the golf course information registered in the golf course database 104 in association with the golf course ID set in the favorite information and inserts it in the anchor tag thereby to generates the affiliate link.

Next, the system controller 20 determines a voice center page which needs to be generated or renewed according to the registered favorite golf course information (step S84). Specifically, the system controller 20 determines that the personal voice center top page 600 (page associated with the member ID, see FIG. 12) or the personal voice center golf course page 700 (page associated with the member ID, see FIG. 13), on which the favorite golf course to be posted and in which the affiliate link is to be set, are pages to be generated or renewed.

Then, the system controller 20 specifies one page from the voice center pages to be generated or renewed (step S58).

Next, the system controller 20 determines whether the specified page is already generated or not (step S59). When the page is already generated (step S59, YES), the process goes to step S85. When the specified page is not generated yet (step S59, NO), the page is generated (step S60) before the process goes to step S85.

In step S85, the system controller 20 embeds the generated affiliate link at a predetermined position in HTML data of the specified page.

Next, the system controller 20 determines whether or not generation or renewal is finished as to all of voice center pages which need to be generated or renewed (step S63). When there exists any voice center page which still needs to be generated or renewed (step S63, NO), the process goes to step S58. When there is no voice center page that needs to be generated or renewed (step S63, YES), the processing ends.

Later, the system controller 20 generates or renews pages in which the affiliate link need not be set (for example, my page 300, etc.).

### [4-4. Operation in Affiliate Link Selection]

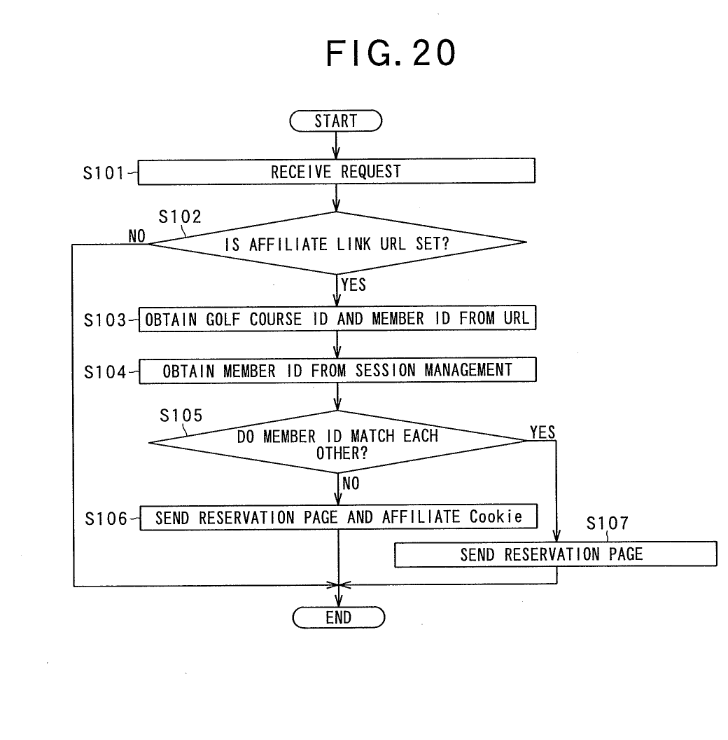

Next description is made about the operation in selecting an affiliate link (steps S10 to S12 in FIG. 17), with reference to FIG. 20.

FIG. 20 is a flow chart showing an example of a processing flow in the affiliate control processing performed by the system controller 20 of the golf course reservation server 1 according to the present embodiment.

A user uses a user terminal 4-k to log in to the golf course reservation system S. On the screen of the user terminal 4-k, a personal voice center top page 600 (see FIG. 11), a personal voice center golf course page 700 (see FIG. 12) or a comment detail page 800 (see FIG. 13) is displayed.

Here, when the user selects an affiliate link displayed on the screen (a golf course name link 621 of the favorite golf courses 620 or a reservation calendar button 670, 740 or 820 corresponding to a comment), the user terminal 4-k sends the golf course reservation server 1 an access request having set therein the URL associated with the selected affiliate link.

On the other hand, when the user selects another link, button or the like, the user terminal 4-k sends the golf course reservation server 1 another request having no affiliate URL set therein.

Then, the system controller 20 of the golf course reservation server 1 receives a certain request as shown in FIG. 20 (step S101).

Then, the system controller 20 determines whether or not the affiliate URL is set in the received request, for example, by determining whether or not the URL set in the request header contains an identifier for identifying the affiliate (step S102). When the affiliate URL is not set (step S102, NO), the affiliate control processing is finished and the processing according to the request is performed.

On the other hand, when the affiliate URL is set (step S102, YES), the system controller 20 obtains a golf course ID and a member ID from the URL (step S103).

Then, the system controller 20 obtains a member ID from the session management (step S104).

Then, the system controller 20 determines whether or not the member ID obtained from the affiliate URL matches the member ID obtained from the session management (step S105). When they do not match each other (step S105, NO), the process goes to step S106, while when they matches each other (step S105, YES), the process goes to step S107. In other words, the system controller 20 makes this determination to control the transmission of the affiliate Cookie in such a manner that when the user himself who has selected the affiliate link is the comment poster or favorite registrant associated with the affiliate link, the reward points as to the reservation by the user is not given.

When the member IDs do not match each other, the system controller 20 sends the user terminal 4-k a reservation page of a golf course indicated by the golf course ID and also sends the user terminal 4-k the affiliate Cookie in step S106. Specifically, the system controller 20 sets the member ID obtained from the affiliate URL in Cookie and sets a date of 30 days later as an expiration date of Cookie to generates the affiliates Cookie. The system controller 20 then sets the affiliate Cookie in a response header for sending the reservation page and sends it together with the reservation page to the user terminal 4-k. Here, the processing ends.

Receiving the reservation page and the affiliate Cookie, the user terminal 4-k displays the reservation page on the screen and stores the affiliate Cookie.

On the other hand, when the member IDs matches each other, the system controller 20 sends the user terminal 4-k the reservation page only in step S107, and the processing ends.

### [4-5. Operation in Reservation]

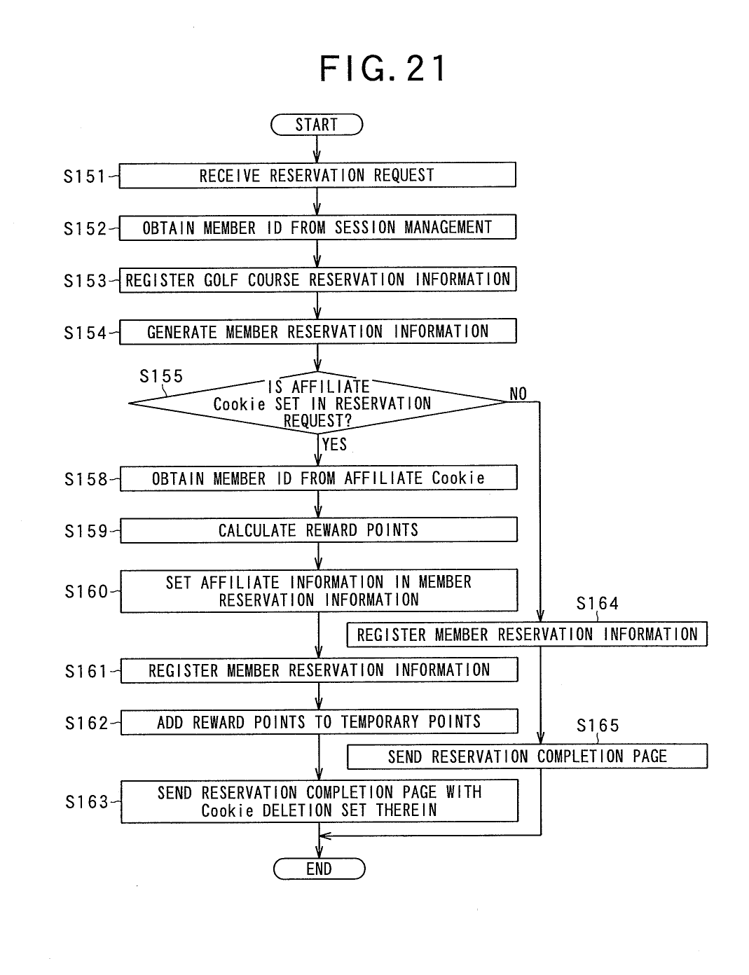

Next description is made about the operation in making a reservation of a golf course (steps S13 and S14 in FIG. 17) with reference to FIG. 21.

FIG. 21 is a flow chart showing an example of a processing flow in the reservation processing performed by the system controller 20 of the golf course reservation server 1 according to the present embodiment.

A user uses a user terminal 4-k to log in to the golf course reservation system S, and a reservation page is displayed on the screen of the user terminal 4-k. Thereafter, the user operates to select a play date, the number of groups, the number of players using the golf course, or the like. In response to this operation, the user terminal 4-k sends the golf course reservation server 1 a request, and in response to this request, the golf course reservation server 1 sends the user terminal 4-k a page for making reservation of the golf course.

Then, when the user selects the reservation button for fixing the reservation, the user terminal 4-k sends the golf course reservation server 1 a reservation request in which a golf course ID of the golf course to reserve, a play date and the like are set.

Then, the system controller 20 of the golf course reservation server 1 receives the reservation request as shown in FIG. 21 (step S151).

Next, the system controller 20 obtains a member ID of the user from the session management (step S152) and registers golf course reservation information in the golf course database 104 (step S153). Specifically, the system controller 20 generates the golf course reservation information based on the information set in the reservation request, the member ID, and the like. Then, the system controller 20 generates a new reservation number and sets the same in the golf course reservation information. Finally, the system controller 20 registers the golf course reservation information in association with the golf course ID set in the reservation request.

Then, the system controller 20 generates member reservation information based on the information set in the reservation request, the member ID, the reservation number and the like (step S154).

Next, the system controller 20 determines whether or not the affiliate Cookie is set in the reservation request (step S155).

When the affiliate Cookie is stored in the user terminal 4-k and the reservation is fixed through the reservation page displayed on the screen of the user terminal 4-k in the above-described affiliate control processing (FIG. 20), the stored affiliate Cookie is set in the reservation request. In addition, even when the reservation is not fixed in the reservation page on the day, the affiliate Cookie can be set in the reservation request as far as reservation is fixed within 30 days from the day as the affiliate Cookie is stored in the user terminal 4-k for 30 days. In such cases, the system controller 20 determines that the affiliate Cookie is set in the reservation request (step S155, YES), and the process goes to step S158.

When the user goes to the reservation page without using the affiliate link (for example, when a reservation is made by searching a golf course which matches user requirements from a golf course search page), the affiliate Cookie is not stored in the user terminal 4-k. In addition, when the affiliate Cookie is once stored in the user terminal 4-k and 30 days have passed, the affiliate Cookie is deleted. In such cases, the system controller 20 determines that no affiliate Cookie is set in the reservation request (step S155, NO), and the process goes to step S164.

In step S158, the system controller 20 obtains a member ID from the affiliate Cookie and calculates reward points in accordance with the reservation fee (step S159).

Then, the system controller 20 sets, in the generated member reservation information, the member ID obtained from the affiliate Cookie and the calculated reward points as affiliate information (step S160), and registers the member reservation information in the member use information database 102 in association with the member ID obtained from the session management (step S161).

Then, the system controller 20 adds the reward points to the temporary points in the member information registered in the member information database 101 in association with the member ID obtained from the affiliate Cookie to renew the temporary points (step S162).

Next, the system controller 20 sends the user terminal 4-k a reservation completion page which shows that the reservation is completed and sets the expiration date of Cookie corresponding to the affiliate Cookie to a past date (that is, sets to delete the Cookie) and sends the Cookie to the user terminal 4-k (step S163). Here, the processing ends. Then, the affiliate Cookie is deleted in the user terminal 4-k.

When receiving the reservation completion page and the Cookie, the user terminal 4-k displays the reservation completion page on the screen and deletes the Cookie as the expiration date of the affiliate Cookie has passed.

In this way, when a reservation is made via the affiliate link, the system controller 20 gives, as temporary points, reward points for the comment poster or favorite registrant associated with the affiliate link, and sets the affiliate information in the member reservation information.

When the affiliate Cookie is not set in the reservation request, the system controller 20 registers the generated member reservation information in the member use information database 102 in association with the member ID obtained from the session management in step S164.

Then, the system controller 20 sends the user terminal 4-k the reservation completion page (step S165), and the processing ends.

### [4-6. Operation in Canceling Reservation]

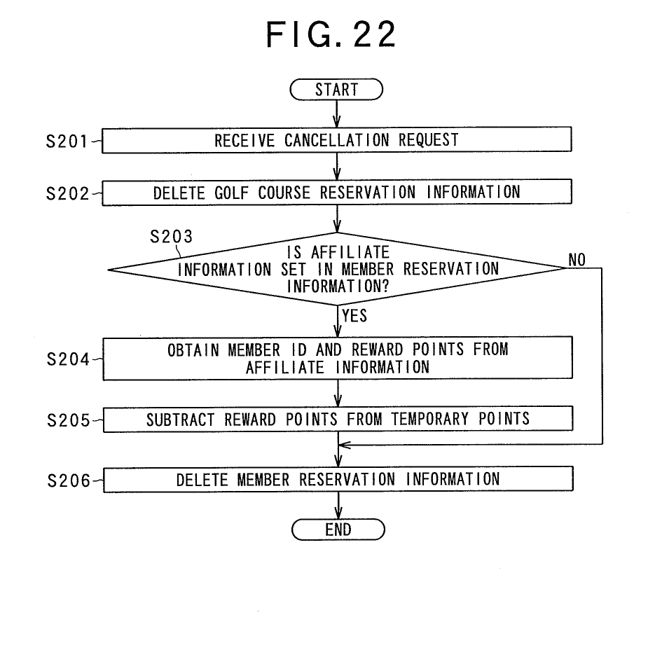

Next description is made about the operation of canceling a reservation of a golf course with reference to FIG. 22.

FIG. 22 is a flow chart showing an example of a processing flow in the reservation canceling processing performed by the system controller 20 of the golf course reservation server 1 according to the present embodiment.

A user uses a user terminal 4-k to log in to the golf course reservation system S and a my page 300 (see FIG. 8) is displayed on the screen of the user terminal 4-k. When the user selects a reservation status check, change and cancellation link in the menu selection area 330 displayed on the screen, the user terminal 4-k sends the golf course reservation server 1 a request and the golf course reservation server 1 sends the user terminal 4-k a reservation status check, change and cancellation page. In the reservation status check, change and cancellation page, a current reservation status of the user is displayed.

Here, when the user selects a cancel button corresponding to a certain reservation, the user terminal 4-k sends the golf course reservation server 1 a cancellation request with a reservation number corresponding to the reservation set therein.

Then, the system controller 20 of the golf course reservation server 1 receives the cancellation request as shown in FIG. 22 (step S201).

Then, the system controller 20 finds in the golf course information database 104 the golf course reservation information associated with the reservation number set in the cancellation request and deletes the golf course reservation information (step S202).

Next, the system controller 20 finds in the member use information database 102 member reservation information associated with the reservation number and determines whether or not affiliate information is set in the member reservation information (step S203).

Here, when no affiliate information is set (step S203, NO), the system controller 20 deletes the member reservation information (step S206) and the processing ends. When the affiliate information is set (step S203, YES), the process goes to step S204.

In step S204, the system controller 20 obtains the member ID and the reward points from the affiliate information in the member reservation information, and subtracts the reward points from the temporary points in the member information registered in the member information database 101 in association with the member ID to renew the temporary points (step S205).

Then, the system controller 20 deletes the member reservation information (step S206), and the processing ends.

Thus, the system controller 20 controls in such a manner that the reward points are not given when a reservation is canceled before use of the golf course.

Although the above-described configuration is adopted in this embodiment, it may be modified, for example, as follows: in the affiliate, the affiliate reward points are not given as temporary points but given for the first time as fixed points to the user when the reward is fixed. In this configuration, steps S203 to S205 in FIG. 22 are omitted.

### [4-7. Operation in Fixing a Play]

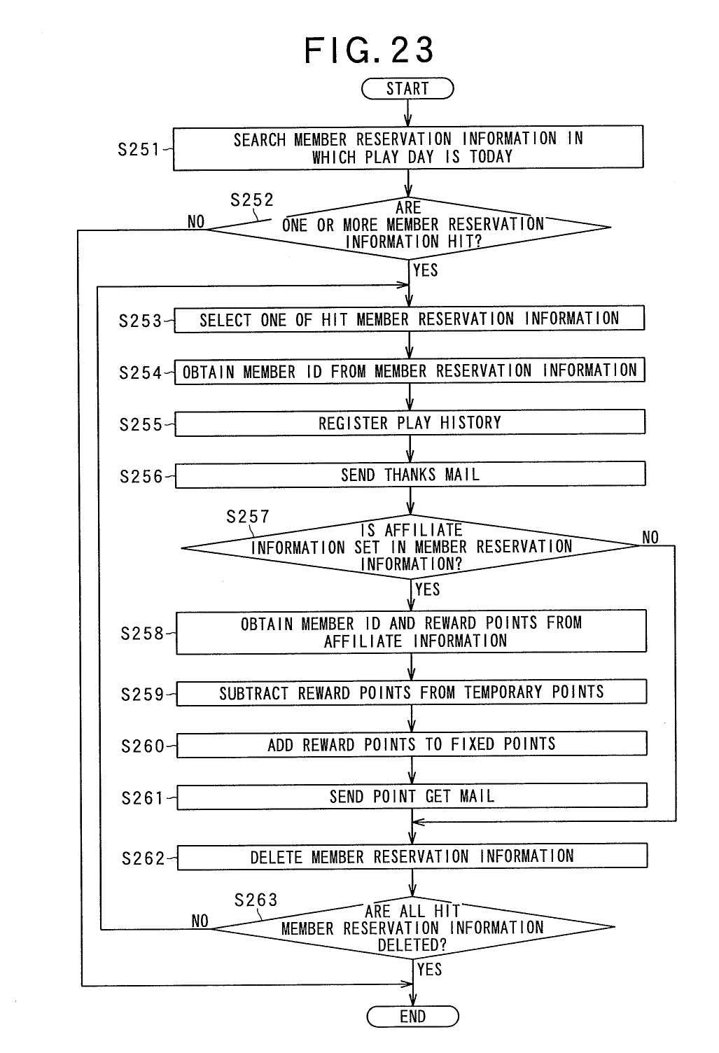

Next description is made about the operation when a golf play of the reservation is fixed (steps S15 and S16 in FIG. 17) with reference to FIG. 23.

FIG. 23 is a flow chart showing an example of a processing flow in the golf play fixing processing performed by the system controller 20 of the golf course reservation server 1 according to the present embodiment.

In the golf course reservation server 1, for example, the play fixing processing is performed once a day (when a predetermined time (e.g., 0 o'clock) has come).

When the play fixing processing is performed, the system controller 20 finds in the member use information database 102 member reservation information in which a play date is set today as shown in FIG. 23 (step S251).

Then, the system controller 20 determines whether or not one or more member reservations are found (step S252). When no member reservation information is found (step S252, NO), the processing ends. When one or more member reservations are found (step S252, YES), the process goes to step S253.

In step S253, the system controller 20 specifies one of the found member reservations in step S253.

Then, the system controller 20 obtains a member ID from the specified member reservation information (step S254).

The system controller 20 then generates a play history based on the member reservation information and registers it in the member use information database 102 in association with the obtained member ID (step S255).

Next, the system controller 20 sends a thanks mail addressed to an electronic mail address obtained from member information registered in the member information database 101 in association with the obtained member ID (step S256). A main body of this thanks mail contains a message showing thanks for use of the golf course reservation system S, a name of the reserved golf course, a play date and the like.

Then, the system controller 20 determines whether or not the affiliate information is set in the member reservation information (step S257). When the affiliate information is set (step S257, YES), the process goes to step S258. When no affiliate information is set (step S257, NO), the process goes to step S262.

In step S258, the system controller 20 obtains a member ID and reward points from the affiliate information.

Then, the system controller 20 subtracts the reward points from the temporary points in the member information registered in the member information database 101 in association with the obtained member ID to renew the temporary points (step S259) and add the reward points to the fixed points to renew the fixed points (step S260).

Then, the system controller 20 sends a point get mail addressed to an electronic mail address obtained from the member information registered in the member information database 101 in association with the obtained member ID (step S261). This point get mail contains in its main body a message of getting a reward, number of obtained points, a reservation date, a reserved golf course name, a play date and the like. In this embodiment, such a mail is to be sent each time when the affiliate reward is confirmed. However, a mail that notifies the user of affiliate results may be sent collectively on a monthly basis.

Next, the system controller 20 deletes the member reservation information (step S262).

In this way, when the play fixing processing for one member reservation is completed, the system controller 20 determines whether or not all of the found member reservations are deleted (step S263). When any of the member reservations is not deleted yet (step S263, NO), the process goes to step S253 to perform play fixing processing. When all of the member reservations are deleted (step S263, YES), the processing ends.

In this way, when a golf course is reserved via an affiliate link and the reserved use (play) of the golf course is fixed, the system controller 20 changes the reward points given to the comment poster or favorite registrant associated with the affiliate link from the temporary points to the fixed points thereby to make the reward points fixed.

As described above, according to the present embodiment, the system controller 20 of the golf course reservation server 1 is configured to generate an affiliate URL which is for making a reservation of a golf course on which a user has posted a comment and for registering reward points given to the user who has posted the comment when an act relating to a transaction of service provided by the commented golf course is committed via the URL. Then, the system controller 20 is configured to embed an affiliate link including the generated affiliate URL in a voice center page in association with the comment input by the user, the affiliate link being selectable, and send this page to a user terminal 4-k used by another user. Then, when another user reads the comment displayed on the screen of the user terminal 4-k based on the voice center page and selects the affiliate link to make a reservation of the commented golf course, and use of the golf course is fixed, reward points are added to the fixed points in the member information corresponding to the member ID of the user who has input the comment.

In addition, the system controller 20 of the golf course reservation server 1 is configured to generate an affiliate URL which is for making a reservation of a golf course designated as a favorite golf course by a user and for registering reward points given to the user who has designated the favorite golf course when an act relating to a transaction of service provided by the golf course designated as a favorite golf course. Then, the system controller 20 is configured to embed an affiliate link including the generated affiliate URL in a voice center page in association with the golf course designated as favorite by the user, the affiliate link being selectable, and send the page to a user terminal 4-k used by another user. Then, when another user views the favorite golf course displayed on the screen of the user terminal 4-k based on the voice center page and selects the affiliate link to make a reservation of the golf course designated as favorite, and use of the reserved golf course is fixed, reward points are added to the fixed points in the member information corresponding to the member ID of the user who has designated the favorite.

Accordingly, a web page with an affiliate link associated with a service provided by the golf course is generated only by inputting a comment or designating the golf course as favorite, and the web page is provided to the user terminal 4-k. With this configuration, the user can get a reward when another user views or reads the comment or favorite golf course and commits an act relating to a transaction without doing operations such as web site management, web page creation and the like.

In addition, the system controller 20 of the golf course reservation server 1 registers in a database a play history associated with a reservation of which use of the golf course by a user who has made the reservation is fixed, and when a comment on the golf course of which the play history is registered is posted, the system controller 20 generates a voice center page with an affiliate link embedded therein. Accordingly, another user can make a reservation after reading proper comments on the golf course.

Further, when receiving an access request from a user terminal 4-k, the system controller 20 of the golf course reservation server 1 is configured to obtain a golf course ID and a member ID from an affiliate URL set in the request, send reservation page of the golf course indicated by the golf course ID and an affiliate Cookie with the member ID set therein and make the user terminal 4-k to store the Cookie. Then, when the affiliate Cookie is set in a reservation request sent from the user terminal 4-k, the system controller 20 is configured to add reward points to temporary points in the member information corresponding to the member ID set in the affiliate Cookie to renew the temporary points, irrespective of whether or not the golf course identified by the golf course ID set in the reservation request, that is, the reserved golf course, matches the golf course corresponding to the reservation page which is sent simultaneously with the affiliate Cookie to the user terminal 4-k.

Accordingly, when a reservation is made via an affiliate link generated by posting a comment or registering a favorite golf course, the comment poster or favorite registrant can get a reward even when the reserved golf course is different from the commented or favorite-registered golf course, which can result in encouraging comment posting or registration of favorite golf courses.

In contrast, the reward may be given to the comment poster or favorite registrant only when the reserved golf course matches a commented golf course or favorite-registered golf course.

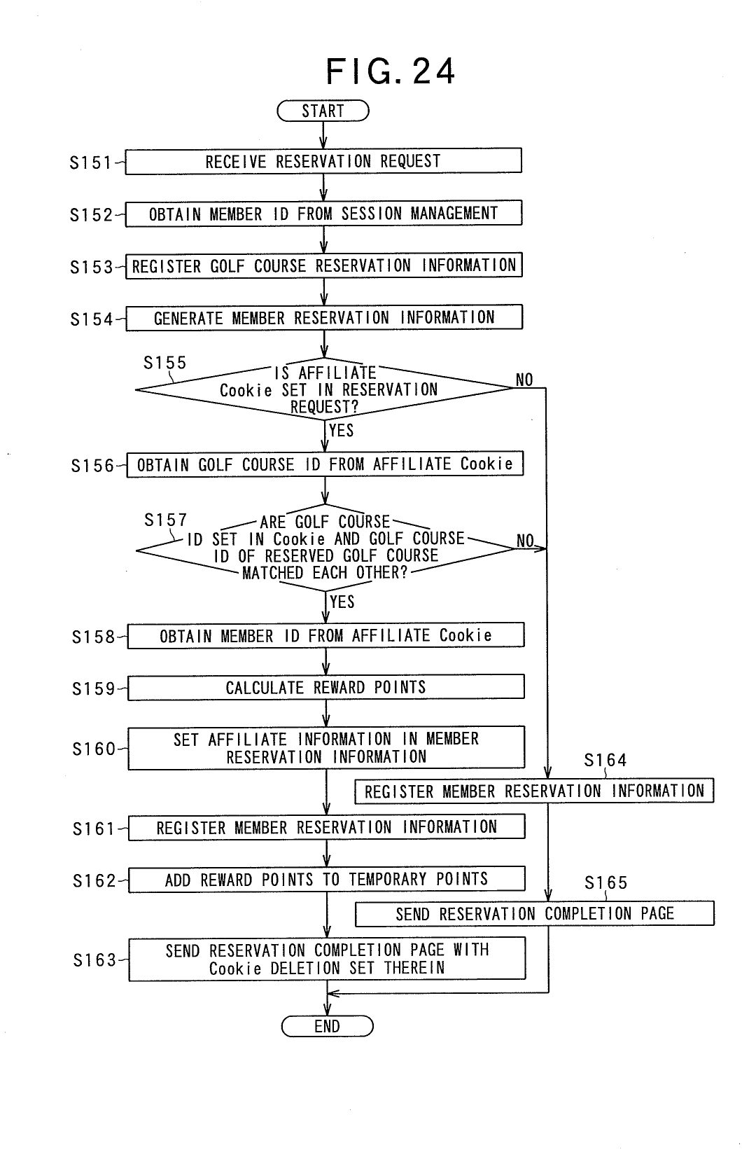

The specific operation in this case is described below. FIG. 24 is a flow chart showing an example of a processing flow in the reservation processing performed by the system controller 20 of the golf course reservation service 1 according to a modification of the present embodiment. The same elements as those in FIG. 21 are assigned with the same reference numerals. First, when an affiliate Cookie of the affiliate control processing is sent from the system controller 20 of the golf course reservation server 1 to the user terminal 4-k (see FIG. 20) (step S106), the affiliate Cookie contains a golf course ID obtained from the affiliate URL and a member ID.

Then, in the reservation processing shown in FIG. 24, when the affiliate Cookie is set in the reservation request (step S155, YES), the system controller 20 obtains the golf course ID from the affiliate Cookie (step S156) and determines whether the obtained golf course ID matches a golf course ID of a reserved golf course set in the reservation request (step S157). When they are matched (step S157, YES), the process goes to step S158, in which reward points are given as temporary points. When they are not matched (step S157, NO), the process goes to step S164 and control is made not to give the reward points.

Further, in the above-described embodiment, a voice center page with an affiliate link embedded in is generated in advance when a comment registration request having a comment or the like input by a user set therein is received or when a favorite golf course registration request is received. However, the voice center page may not be generated in advance since comment management information or favorite golf course information is generated in the member use database 102. For example, an affiliate link may be generated based on the comment management information or favorite golf course information to generate the voice center page to be sent to the user terminal 4-k when a request of the voice center page is received from the user terminal 4-k. Alternatively, the voice center page may be generated in such a manner that an affiliate URL or an affiliate link is first generated and registered in a database or the like in association with a member ID and, when a request of a voice center page is received, the registered affiliate URL or affiliate link is used to generate the voice center page.

Furthermore, in the above-described embodiment, the affiliate link is embedded when a comment is posted for a play. However, the present invention is not limited to such a configuration, and an affiliate link may also be created when a user who has not made a reservation posts a comment or when a user who has made a reservation posts a comment not associated with the play.

Furthermore, in the above-described embodiment, a so-called result-oriented reward system is adopted, in which a reward is given to a comment poster or a favorite registrant when a reservation is made and the reserved use of the golf course is fixed. However, reward points may be given, for example, when an affiliate link embedded in the voice center page is selected by a user (when an access request with an affiliate URL set therein is received by the golf course reservation server 1 (or when a corresponding voice center page is sent)) (so-called click guaranteed system) or when a user makes a reservation (when member reservation information is registered).

Furthermore, in the above-described embodiment, the reward information of the present invention is reward points that can be used in the golf course reservation system. However, the reward information may be, for example, information showing a referral fee to be paid as a reward or information relating to a present given as a reward.

Furthermore, in the above-described embodiment, the transaction object of the present invention is a golf course service. However, for example, the transaction object may be another service or a product.

Furthermore, in the above-described embodiment, the act relating to a transaction of the present invention is a service reservation. However, the act may be, for example, a sales transaction of a service or product, a service member registration, a document request of a service or product or the like.

1. A transaction system comprising:
a terminal device connectable to a network; and
a transaction processing device providing screen information constituting a screen display of information concerning a transaction object to the terminal device via the network and registering in a database reward information showing a reward for an act concerning a transaction performed via link information embedded in the screen information,
the transaction processing device including:
comment information receiving means for receiving comment information on the transaction object input by a user from a comment input terminal device as the terminal device used by the user;
user identification information recognizing means for recognizing user identification information for identifying the user who has input the comment information;
link information generating means for generating the link information associated with the transaction object commented by the received comment information and used for registering the reward information for the user identified by the recognized user identification information;
screen information generating means for generating the screen information constituting the screen display including the comment information in such a way that the link information is selectably embedded in association with the comment information; and
screen information sending means for sending the generated screen information to a read terminal device as the terminal device used by another user,
the comment input terminal device including:
comment information sending means for sending the comment information input by the user to the transaction processing device, and
the read terminal device including:
screen information receiving means for receiving the screen information sent from the transaction processing device; and
display means for displaying the comment information on a screen based on the received screen information in such a way that the link information embedded is selectable.

2. A transaction system comprising:
a terminal device connectable to a network; and
a transaction processing device providing screen information constituting a screen display of information concerning a transaction object to the terminal device via the network and registering in a database reward information showing a reward for an act concerning a transaction performed via link information embedded in the screen information, including:
favorite designation information receiving means for receiving favorite designation information showing the transaction object designated as favorite by a user from a favorite designation terminal device as the terminal device used by the user;
user identification information recognizing means for recognizing user identification information for identifying the user who has performed the favorite designation;
link information generating means for generating the link information associated with the transaction object of the received favorite designation information and used for registering the reward information in association with the received user identification information in the database;
screen information generating means for generating the screen information constituting the screen display including favorite designation information showing that the transaction object designated is a favorite of the user in such a way that the generated link information is selectably embedded in association with the transaction object; and
screen information sending means for sending the generated screen information to a read terminal device as the terminal device used by another user,
the favorite designation terminal device including:
favorite designation information sending means for sending the favorite designation information showing the transaction object designated as favorite by the user to the transaction processing device, and
the read terminal device including:
screen information receiving means for receiving the screen information sent from the transaction processing device; and
display means for displaying the favorite designation information on a screen based on the received screen information in such a way that the link information embedded is selectable.

3. A transaction processing device providing screen information constituting a screen display of information concerning a transaction object to a terminal device via a network and registering in a database reward information showing a reward for an act concerning a transaction performed via link information embedded in the screen information,
the transaction processing device comprising:
comment information receiving means for receiving comment information on the transaction object input by a user from a comment input terminal device as the terminal device used by the user;
user identification information recognizing means for recognizing user identification information for identifying the user who has input the comment information;
link information generating means for generating the link information associated with a transaction of the transaction object commented by the received comment information and used for registering the reward information for the user identified by the recognized user identification information;
screen information generating means for generating the screen information constituting the screen display including the comment information in such a way that the generated link information is selectably embedded in association with the comment information; and
screen information sending means for sending the generated screen information to a read terminal device as the terminal device used by another user.

4. The transaction processing device according to claim 3,
wherein in the database, transaction information of the transaction object previously transacted by the user is registered in association with the user identification information of the user, and
the link information generating means generates the link information in association with the comment information commenting on the transaction object shown by the transaction information associated with the recognized user identification information.

5. The transaction processing device according to claim 3 or 4, further comprising:
comment information registering means for registering the received comment information in the database in association with the recognized user identification information and registering transaction object identification information of the transaction object commented by the comment information in the database in association with the comment information,
wherein the link information generating means generates the link information associated with the transaction of the transaction object identified by the transaction object identification information associated with the registered comment information in such a manner as to allow the user identification information associated with the comment information to be specified, and
the screen information generating means generating the screen information of the registered comment information.

6. A transaction processing device providing screen information constituting a screen display of information concerning a transaction object to a terminal device via a network and registering in a database reward information showing a reward for an act concerning a transaction performed via link information embedded in the screen information, the transaction processing device comprising:
favorite designation information receiving means for receiving favorite designation information showing the transaction object designated as favorite by a user from a favorite designation terminal device as the terminal device used by the user;
user identification information recognizing means for recognizing user identification information for identifying the user who has performed the favorite designation;
link information generating means for generating the link information associated with a transaction of the transaction object shown by the received favorite designation information and used for registering the reward information in association with the recognized user identification information in the database;
screen information generating means for generating the screen information constituting the screen display including favorite information showing that the transaction object designated is a favorite of the user in such a way that the generated link information is selectably embedded in association with the transaction object; and
screen information sending means for sending the generated screen information to a read terminal device as the terminal device used by another user.

7. The transaction processing device according to claim 6,
wherein in the database, transaction information of the transaction object previously transacted by the user is registered in association with the user identification information of the user, and
the link information generating means generates the link information in association with favorite designation by the user of the transaction object shown by the transaction information associated with the recognized user identification information.

8. The transaction processing device according to claim 6 or 7,
wherein in the database, favorite management information for managing the favorite information is registered in association with the user identification information,
the transaction processing device further comprises favorite information registering means for registering transaction object identification information for identifying the transaction object shown by the received favorite designation information in the favorite management information associated with the recognized user identification information,
the link information generating means generates the link information associated with the transaction of the transaction object identified by the registered transaction object identification information in such a manner as to allow the user identification information associated with the favorite management information to be specified, and
the screen information generating means generates the screen information of the favorite information of the transaction object identified by the registered transaction object identification information.

9. The transaction processing device according to any one of claims 3 to 8,
wherein the link information generating means generates the link information in such a manner as to allow the recognized user identification information to be specified, and
the transaction processing device further comprises:
access request information receiving means for receiving access request information containing the link information and sent from the read terminal device based on selection of the link information by the other user via the sent screen information;
transaction object screen information sending means for sending the read terminal device, transaction object screen information constituting a screen display required for performing a transaction of the transaction object associated with the link information contained in the received access request information;
transaction request receiving means for receiving transaction request information showing a transaction request sent based on a direction of the other user from the read terminal device which has received the sent transaction object screen information;
transaction registering means for registering in the database transaction registration information showing registration of the transaction based on the received transaction registration information;
transaction fixing recognizing means for recognizing fixing of the transaction shown by the registered transaction registration information; and
reward information registering means for registering the reward information in association with the user identification information specified by the link information contained in the access request information in at least one case of a case where the access request information is received, a case where the transaction registration information is registered and a case where fixing of the transaction is recognized.

10. A screen information generating method for a transaction processing device providing screen information constituting a screen display of information concerning a transaction object to a terminal device via a network and registering in a database reward information showing a reward for an act concerning a transaction performed via link information embedded in the screen information, the screen information generating method comprising:
a comment information receiving process of receiving comment information on the transaction object input by a user from a comment input terminal device as the terminal device used by the user;
a user identification information recognizing process of recognizing user identification information for identifying the user who has input the comment information;
a link information generating process of generating the link information associated with the transaction object commented by the received comment information and used for registering the reward information for the user identified by the recognized user identification information;
a screen information generating process of generating the screen information constituting the screen display including the comment information in such a way that the generated link information is selectably embedded in association with the comment information; and
a screen information sending process of sending the generated screen information to a read terminal device as the terminal device used by another user.

11. A screen information generating method for a transaction processing device providing screen information constituting a screen display of information concerning a transaction object to a terminal device via a network and registering in a database reward information showing a reward for an act concerning a transaction performed via link information embedded in the screen information,
the screen information generating method comprising:
a favorite designation information receiving process of receiving favorite designation information showing the transaction object designated as favorite by a user from a favorite designation terminal device as the terminal device used by the user;
a user identification information recognizing process of recognizing user identification information for identifying the user who has performed the favorite designation;
a link information generating process of generating the link information associated with a transaction of the transaction object shown by the received favorite designation information and used for registering the reward information in association with the recognized user identification information in the database;
a screen information generating process of generating the screen information constituting the screen display including favorite information showing that the transaction object designated is a favorite of the user in such a way that the link information is selectably embedded in association with the transaction object; and
a screen information sending process of sending the generated screen information to a read terminal device as the terminal device used by another user.

12. A screen information generation processing program for a computer included in a transaction processing device providing screen information constituting a screen display of information concerning a transaction object to a terminal device via a network and registering in a database reward information showing a reward for an act concerning a transaction performed via link information embedded in the screen information,
the screen information generation processing program making the computer function as:
comment information receiving means for receiving comment information on the transaction object input by a user from a comment input terminal device as the terminal device used by the user;
user identification information recognizing means for recognizing user identification information for identifying the user who has input the comment information;
link information generating means for generating the link information associated with a transaction of the transaction object commented by the received comment information and used for registering the reward information for the user identified by the recognized user identification information;
screen information generating means for generating the screen information constituting the screen display including the comment information in such a way that the link information is selectably embedded in association with the comment information; and
screen information sending means for sending the generated screen information to a read terminal device as the terminal device used by another user.

13. A screen information generation processing program for a computer included in a transaction processing device providing screen information constituting a screen display of information concerning a transaction object to a terminal device via a network and registering in a database reward information showing a reward for an act concerning a transaction performed via link information embedded in the screen information,
the screen information generation processing program making the computer function as:
favorite designation information receiving means for receiving favorite designation information showing the transaction object designated as favorite by a user from a favorite designation terminal device as the terminal device used by the user;
user identification information recognizing means for recognizing user identification information for identifying the user who has performed the favorite designation;
link information generating means for generating the link information associated with a transaction of the transaction object shown by the received favorite designation information and used for registering the reward information in association with the recognized user identification information in the database;
screen information generating means for generating the screen information constituting the screen display including favorite information showing that the transaction object designated is a favorite of the user in such a way that the link information is selectably embedded in association with the transaction object; and
screen information sending means for sending the generated screen information to a read terminal device as the terminal device used by another user.

14. A transaction processing device for providing information concerning a transaction object to a terminal device via a network, comprising:
comment information receiving means for receiving comment information on the transaction object sent from the terminal device based on inputting of a comment by a user;
link generating means for generating an affiliate link containing user identification information for identifying the user who has input the comment;
screen information generating means for generating screen information containing the link and the comment information; and
screen information sending means for sending the generated screen information to another terminal device.

15. A transaction processing device for providing information concerning a transaction object to a terminal device via a network, comprising:
favorite designation information receiving means for receiving favorite designation information on the transaction object designated as favorite sent from the terminal device based on input by a user;
link generating means for generating an affiliate link containing user identification information for identifying the user;
screen information generating means for generating screen information containing the link and information of the transaction object designated as favorite; and
screen information sending means for sending the generated screen information to another terminal device.

16. A recording medium computer-readably having recorded therein the screen information generation processing program according to claim 12 or 13.
